(19) United States
(12) Patent Application Publication
(10) Pub. No.: US 2023/0416929 A1
(43) Pub. Date: Dec. 28, 2023

(54) ENHANCED CONVERSION OF CHEMISORBED CO2 IN AMINEBASED ELECTROCHEMICAL SYSTEMS

(71) Applicant: THE GOVERNING COUNCIL OF THE UNIVERSITY OF TORONTO, Toronto (CA)

(72) Inventors: Edward H. SARGENT, Toronto (CA); Geonhui LEE, Toronto (CA); Yuguang Christopher LI, Toronto (CA)

(21) Appl. No.: 18/038,669

(22) PCT Filed: Nov. 25, 2021
(86) PCT No.: PCT/CA2021/051687

§ 371 Date: May 24, 2023

Related U.S. Application Data
(60) Provisional application No. 63/118,370, filed on Nov. 25, 2020.

(51) Int. Cl. C25B 1/23; C25B 3/09; C25B 3/26; C25B 15/08; C25B 11/091; C25B 11/042; C25B 9/19; C25B 11/065; C25B 15/029

(52) U.S. Cl. CPC C25B 1/23; C25B 3/09; C25B 3/26; C25B 15/083; C25B 11/091; C25B 11/042; C25B 9/19; C25B 11/065; C25B 15/029

(57) ABSTRACT

An electrochemical process, and related method and system to upgrade captured CO₂ into value-added products. CO₂ capture technologies based on chemisorption present the potential to lower net emissions of CO₂ into the atmosphere. The use of alkali cations to tailor the electrochemical double layer allows achieving the valorization of chemisorbed CO₂ in an aqueous amine-based electrolyte, by placing the CO₂ of the amine-CO₂ adduct sufficiently close to the site of an heterogeneous reaction at the working electrode. It is revealed, using electrochemical studies and in-situ surface-enhanced Raman spectroscopy, that a smaller double layer distance can correlate with improved activity for CO₂ to CO from amine solutions.

### TECHNICAL FIELD

The technical field generally relates to carbon dioxide capture and valorization, and more particularly to electrochemical techniques for enhanced conversion of chemisorbed CO₂ into value-added products including CO.

### BACKGROUND

There are various challenges associated with the capture and valorization of CO₂ based on the use of amine solutions. The present electrochemical techniques address at least some of these challenges to achieve an enhanced conversion of CO₂ into value-added products in comparison to known techniques in the field.

### SUMMARY

As will be explained below in relation to various example implementations, the present techniques relate to electrochemical conversion of carbon dioxide CO₂ into value-added products in an amine-based capture solution serving as electrolyte. More particularly, the process, method and system implementations that are proposed herein facilitate enhancement of conversion of chemisorbed CO₂ (in the form of an amine-CO₂ adduct) into CO. In some implementations, the techniques facilitate reducing a distance between the chemisorbed CO₂ and the heterogeneous reaction site at a working electrode. The reduction of distance can be achieved by disrupting the electrochemical double layer (EDL) via the presence of alkali cations competing with the ammonium ions from the amine-based electrolyte.

In one aspect, there is provided an electrolysis process for producing value-added products from an amine-CO₂ electrolyte solution, the process comprising: providing the amine-CO₂ electrolyte solution comprising alkali cations and chemisorbed CO₂ under the form of an amine-CO₂ adduct; and contacting the amine-CO₂ electrolyte solution with a working electrode under applied current density for electrolysing the amine-CO₂ adduct to form a product mixture comprising carbon monoxide (CO) and an amine; wherein the alkali cations are selected to disrupt an electrochemical double layer (EDL) at a surface of the working electrode and enhance electron transfer to the amine-CO₂ adduct.

In some implementations, the process further comprises adding the alkali cations to an amine-CO₂ solution to produce the amine-CO₂ electrolyte solution. Alternatively, the amine-CO₂ solution is a CO₂-enriched amine-based capture solution from an industrial CO₂ absorption process from flue gas.

In another aspect, there is provided an electrochemical process for conversion of CO₂ into value-added products comprising CO, the process comprising: contacting CO₂ with an amine-based capture solution to chemically absorb CO₂ and produce an amine-CO₂ electrolyte solution comprising a carbamate; and electrolysing the carbamate into the value-added products by contacting the amine-CO₂ electrolyte solution with a working electrode under applied current density in presence of alkali cations to form a product mixture comprising carbon monoxide (CO) and an amine; wherein the alkali cations are selected to modify an electrochemical double layer (EDL) at a surface of the working electrode and thereby enhance electron transfer to the carbamate.

In some implementations, the amine-based capture solution comprises the alkali cations.

In some implementations, the process further comprises adding the alkali cations to the amine-CO₂ electrolyte solution before electrolysing the carbamate into the value-added products.

In some implementations, the process further comprises separating the amine from the product mixture and recycling thereof as at least part of the amine-based capture solution.

In some implementations, at least 80% of the chemisorbed CO₂ is converted into CO. Alternatively, at least 90% of the chemisorbed CO₂ is converted into CO.

In some implementations, the alkali cations comprise at least one of K+, Rb+ and Cs+.

In some implementations, a molecular size of the alkali cations is smaller than the molecular size of the ammonium cation from the amine-CO₂ electrolyte solution.

In some implementations, the alkali cations have a Stark tuning slope that is higher than that of the ammonium cation from the amine-CO₂ electrolyte solution.

In some implementations, a Faradaic efficiency (FE) of CO₂-to-CO conversion is at least 30% at the applied current density between 5 mA/cm² and 300 mA/cm². Optionally, the FE of CO₂-to-CO conversion is at least 30% at the applied current density between 5 mA/cm² and 100 mA/cm². Optionally, the FE of CO₂-to-CO conversion is at least 50%. Optionally, the FE of CO₂-to-CO conversion is at least 70%.

In some implementations, a distance between the carbamate and electrons forming an inner layer of the EDL is smaller than the distance resulting from electrolysis in absence of the alkali cations.

In some implementations, the amine is a primary amine. Alternatively, the amine is a secondary amine. Alternatively, the amine is a tertiary amine.

In some implementations, the amine is MEA, DEA or MDEA. Optionally, the amine is NR₁R₂R₃ and each of R₁, R₂ and R₃ is hydrogen, an alkyl group or an aryl group.

In some implementations, a concentration of the alkali cations in the amine-CO₂ electrolyte solution is between 0.1 M and 3 M. Optionally, a concentration of the alkali cations in the amine-CO₂ electrolyte solution is between 0.5 M and 2.5 M. Optionally, a concentration of the alkali cations in the amine-CO₂ electrolyte solution is between 1 M and 2 M.

In some implementations, a concentration in carbamate and ammonium ions in the amine-CO₂ electrolyte solution is between 1 M and 5 M. Optionally, a concentration in carbamate and ammonium ions in the amine-CO₂ electrolyte solution is between 1.5 M and 4.5 M. Optionally, a concentration in carbamate and ammonium ions in the amine-CO₂ electrolyte solution is between 2 M and 4 M. Optionally, a concentration in carbamate and ammonium ions in the amine-CO₂ electrolyte solution is between 2 M and 2.5 M.

In some implementations, the working electrode comprises an electrocatalyst.

In some implementations, the working electrode is fabricated by sputtering a metal on a substrate to form a metal film and spray-coating an ink containing metal nanoparticles onto the metal film.

In some implementations, the working electrode is an Ag cathode, an Ag-carbon black cathode or a Cu cathode.

In some implementations, the process further comprises, before contacting the amine-CO₂ electrolyte solution with the working electrode under applied current density, purging the amine-CO₂ electrolyte solution with an inert gas to remove any dissolved CO₂. For example, the inert gas can be N2.

In some implementations, the process further comprises maintaining the amine-CO₂ electrolyte solution at a temperature between 19° C. and 80° C. during electrolysis. Optionally, the temperature can be maintained between 40° C. and 80° C.

In some implementations, the process further comprises separating CO from the product mixture to produce a CO-enriched stream.

In another aspect, there is provided a method to enhance electrochemical conversion of CO₂ into value-added products in an amine-based electrochemical system, the method comprising adding alkali cations to an amine-based electrolyte solution to form a modified electrolyte solution so as to disrupt an electrochemical double layer (EDL) at a working electrode of the amine-based electrochemical system that generates CO from a carbamate present in the modified electrolyte solution.

The method can further comprise at least one of the features of the processes defined herein.

In another aspect, there is provided an electrochemical system for conversion of chemisorbed CO₂ into CO, the system comprising: a cathodic compartment for containing an amine-CO₂ catholyte solution comprising an amine-CO₂ adduct and alkali cations; an anodic compartment for containing an anolyte solution; a cathode being provided in the cathodic compartment; an anode being provided in the anodic compartment; a reference electrode being provided in the cathodic compartment; a cation exchange cation membrane being provided between the anodic compartment and the cathodic compartment to control ion exchange therebetween; an alkali addition unit having an outlet in fluid communication with a liquid inlet of the cathodic compartment to provide the alkali ions therein; and a power source to provide electrical current at an applied current density and sustain electrolysis of the amine-CO₂ adduct from the amine-CO₂ catholyte solution; wherein the alkali cations are selected to disrupt an electrochemical double layer (EDL) at a surface of the cathode during electrolysis of the amine-CO₂ adduct, and enhance electron transfer to the amine-CO₂ adduct for production of CO.

In some implementations, the alkali addition unit is configured to add the alkali ions to an amine-CO₂ solution flowing into the cathodic compartment via the liquid inlet.

In some implementations, the amine-CO₂ solution is a CO₂-enriched amine-based capture solution from an industrial CO₂ absorption process from flue gas.

In some implementations, the alkali addition unit is configured to add the alkali ions to an amine solution flowing into the cathodic compartment via the liquid inlet.

In some implementations, the cathodic compartment further has a gas inlet for receiving CO₂ and allowing chemisorption of CO₂ by the amine solution to form the amine-CO₂ catholyte solution comprising the amine-CO₂ adduct and the alkali cations, before providing electrical current via the power source.

In some implementations, the cathodic compartment further comprises at least one outlet to recover a product mixture comprising CO and the amine resulting from the electrolysis of the amine-CO₂ adduct.

In some implementations, the cathodic compartment comprises a liquid outlet to recover a liquid component comprising the amine. Additionally, the cathodic compartment can include a gas outlet to recover a gas component comprising CO.

In some implementations, the alkali cations comprise at least one of K+, Rb+ and Cs+.

In some implementations, a molecular size of the alkali cations is lower than the molecular size of the ammonium cations of the amine-CO₂ catholyte solution.

In some implementations, the alkali cations have a Stark tuning slope that is higher than the one of the ammonium cations of the amine-CO₂ catholyte solution.

In some implementations, a Faradaic efficiency (FE) of CO₂-to-CO is at least 30% at an applied current density between 5 mA/cm² and 300 mA/cm². Optionally, the FE of CO₂-to-CO is at least 30% at an applied current density between 5 mA/cm² and 100 mA/cm². Optionally, the FE of CO₂-to-CO is at least 50%. Optionally, the FE of CO₂-to-CO is at least 70%.

In some implementations, a distance between the amine-CO₂ adduct and electrons forming an inner layer of the EDL is lower than the distance resulting from electrolysis of the amine-CO₂ adduct in absence of the alkali cations.

In some implementations, the amine-CO₂ adduct is a carbamate deriving from a primary amine. Alternatively, the amine-CO₂ adduct is a carbamate deriving from a secondary amine. Alternatively, the amine-CO₂ adduct is a carbamate derived from a tertiary amine. Optionally, the amine-CO₂ adduct can be a carbamate derived from MEA, DEA or MDEA. Optionally, the amine can be NR₁R₂R₃ and each of R₁, R₂ and R₃ is hydrogen, an alkyl group or an aryl group.

In some implementations, the system further comprises a control unit that is operatively connected to the alkali addition unit to provide the amine-CO₂ catholyte solution with a molar concentration ratio of the alkali cations over the amine-CO₂ adduct between 0.01 and 3. Optionally, the molar concentration ratio of the alkali cations over the amine-CO₂ adduct is between 0.1 and 1. Optionally, a molar concentration of the alkali cations is between 0.1 M and 3 M. Optionally, a molar concentration of the amine-CO₂ adduct is between 1 M and 5 M.

In some implementations, the cathode comprises an electrocatalyst.

In some implementations, the cathode is fabricated by sputtering a metal on a substrate to form a metal film and spray-coating an ink containing metal nanoparticles onto the metal film.

In some implementations, the substrate is carbon paper or PTFE.

In some implementations, the cathode is an Ag cathode, an Ag/carbon black cathode or a Cu cathode.

In some implementations, the anolyte solution is a KOH solution.

In some implementations, the reference electrode is an Ag/AgCl electrode.

In some implementations, the cation exchange membrane is a Nafion membrane.

In some implementations, the system is a three-electrode system.

In some implementations, the anode comprises Pt, optionally provided in the form of a foil.

In some implementations, the system is a flow cell system.

In some implementations, the anode comprises Ni, optionally provided in the form of a foam.

In some implementations, the system further comprises a peristaltic pump to circulate the anolyte solution and the amine-CO₂ catholyte solution within the flow cell system.

In another aspect, there is provided an electrolysis process for producing CO from an amine-CO₂ electrolyte solution, the process comprising: obtaining an amine-CO₂ electrolyte solution derived from a CO₂ capture system, the amine-CO₂ electrolyte solution comprising chemisorbed CO₂ in the form of an amine-CO₂ adduct; adding alkali cations to the amine-CO₂ electrolyte solution to form a modified electrolyte solution having a molar concentration ratio of alkali cations over amine-CO₂ adduct between 0.01 and 3; subjecting the modifying solution to electrocatalysis to generate CO and an amine RNH₂ with R being an alkyl group, from the amine-CO₂ adduct at a working electrode under an applied current density between 5 and 300 mA/cm².

In some implementations, the applied current density is between 5 and 100 mA/cm². For example, the applied current density is between 10 and 100 mA/cm².

In some implementations, the molar concentration ratio of alkali cations over amine-CO₂ adduct between 0.1 and 1.

Various implementations, features and aspects of the present techniques are described herein, including in the claims, figures and following description.

### BRIEF DESCRIPTION OF DRAWINGS

The Figures describe various aspects and information regarding the techniques described and claimed herein.

FIG. 1 includes three graphs illustrating a performance of an electrochemical double layer produced in a 2M MEA electrolyte with an Ag electrocatalyst: Graph 1(a) shows Faradaic efficiency (%) and partial current density of CO J_{CO} for different potentials; Graph 1(b) shows electrochemical impedance spectroscopy for the electrolyte collected at Open-Circuit Potential (OCP), ca. −0.15 V vs. Ag/AgCl with the inset being the equivalent circuit and the fit values of each of the components; Q2 and Q3 being the constant phase element; R1 being the series resistance; R2 and R3 being the charge transfer resistances; and the error bar of each component denoting the standard deviation of three fit values from independent measurements; Graph 1(c) shows In-situ surface-enhanced Raman spectroscopy for the 2 M MEA electrolyte.

FIG. 2 is a schematized electronic transfer near the electrode surface for the proposed electrochemical double layer for (a) an MEA-CO₂ electrolyte (left) and (b) MEA-CO₂ with alkali salt electrolyte (right).

FIG. 3 includes three graphs illustrating a performance of anelectrochemical double layer produced in a 2M MEN 2M KCl electrolyte With an Ag electrocatalyst: Graph 3(a) shows Faradaic efficiency and partial current density of CO (j_{CO}) for different potentials; Graph 3(b) shows electrochemical impedance spectroscopy for the electrolyte collected at OCP, ca. −0.145 V vs. Ag/AgCl, with the inset being the equivalent circuit and the fit values of each components; R1 and R2 being the series resistance and charge transfer resistance respectively; Q2 being the constant phase element; and the error bar of each components denoting the standard deviation of three fit values from independent measurements; Graph 3(c) shows In-situ surface-enhanced Raman spectroscopy for the 2 M MEA/2 M KCl electrolyte.

FIG. 4 includes two graphs illustrating a performance of an electrochemical double layer tailored using different cations: Graph 4(a) shows Faradaic efficiency of CO conversion (%) for different alkali cation salts solution in the MEA electrolyte at an applied potential range of ˜0.58 V and −0.66 V vs. RHE, with the error bars representing the standard deviation of measurements over three independent samples; and Graph 4(b) shows an effect of a cation change on the CO adsorption (CO_{ads}) stretching frequency shift at different applied potentials, the error bars indicate the standard deviation of the CO_{ads} frequency based on three independent measurements.

FIG. 5 includes three graphs illustrating an electrochemical performance of the electrolysis of captured CO₂: Graph 5(a) shows a potential j-V curve at 60° C. for a 30 wt % of MEA plus 70 wt % of H₂O with 2 M KCl electrolyte in a flow cell system, with the error bars representing the standard deviation of potentials from three independent measurements; Graph 5(b) shows product distribution of MEA-CO₂ conversion to H2 and CO at different applied current densities, ranging from 5 mA/cm² to 100 mA/cm² in a flow cell system, with the error bars representing the standard deviation of three independent measurements; and Graph 5(c) shows recycling performance of the 2 M MEA with 3 M KCl electrolyte at a constant applied current density of 10 mA/cm² heated to 30° C. in a three-electrode configuration, with the products being collected within 1 hour.

FIG. 6 includes a scheme of an amine-CO₂ electrolysis system and a graph showing electrochemical performance of the system for different amines: Scheme 6(a) shows the electrochemical scheme for the electrolysis of the amine-CO₂ system via an in-situ CO₂ generation method from the bipolar membrane (BPM); and Graph 6(b) shows product distribution (CO and H₂) with an Ag catalyst in three different aqueous-amine electrolytes (monoethanolamine (MEA), diethanolamine (DEA) and N-methyldiethanolamine (MDEA)) at different applied current densities, ranging from 50 mA/cm² to 200 mA/cm², with the error bars representing the standard deviation of two independent measurements.

FIG. 7 includes four scanning electron microscope (SEM) images of an as-synthesized Ag catalyst: Images 7a and 7b showing the Ag catalyst surface before electrochemical reduction reactions; and Images 7c and 7d showing the Ag catalyst surface after electrochemical reduction reactions.

FIG. 8 includes two graphs illustrating an X-ray photoelectron spectroscopy (XPS) spectra of an as-synthesized Ag catalyst: Graph 8(a) showing XPS survey spectra of the as-synthesized Ag catalyst; and Graph 8(b) showing the Ag 3d detailed spectra of the Ag catalyst.

FIG. 9 includes two graphs illustrating an X-ray diffraction (XRD) pattern of the as-synthesized Ag catalyst: Graph 9(a) showing the X-ray diffraction (XRD) pattern before electrochemical reduction reaction; and Graph 9(b) showing the X-ray diffraction (XRD) pattern after electrochemical reduction reaction, with peaks labelled with “●” being contributed from the carbon substrate.

FIG. 10 includes two graphs illustrating an electrochemical impedance spectra for different electrolytes: Graph 10(a) shows the electrochemical impedance spectroscopy for a 2 M MEA electrolyte at −0.4 V vs. RHE, with the inset being the equivalent circuit and the fit values of each of the components, Q2 and Q3 being the constant phase element, R1 being the series resistance, and R2 and R3 being the charge transfer resistances; and Graph 10(b) shows the electrochemical impedance spectroscopy for a 2 M MEA/2 M KCl electrolyte at −0.4 V vs. RHE, with the inset being the equivalent circuit and the fit values of each of the components, R1 and R2 being the series resistance and charge transfer resistance respectively, and Q2 being the constant phase element.

FIG. 11 includes two graphs of an In-situ surface-enhanced Raman spectroscopy ranging 1000 cm⁻¹ to 1700 cm⁻¹: Graph 11(a) showing the spectroscopy for a 2 M MEA electrolyte; and Graph 11(b) showing the spectroscopy for a 2M MEA electrolyte with 2M of KCl.

FIG. 12 is a graph showing Faradaic Efficiency towards CO (%) for a MEA/KCl electrolyte with varying concentrations of the alkali cation, and the concentration of MEA in electrolytes being 2 M in all cases, with the error bars corresponding to the standard deviation of more than three independent measurements.

FIG. 13 includes two graphs of GC-MS analysis of CO produced from amine-¹³CO₂ and amine-¹²CO₂ electrolysis with an Ag catalyst: Graph 13(a) shows spectra of CO produced from the MEA-¹³CO₂ electrolysis (pattern of ¹³CO (M/Z=29)); and Graph 13(b) shows spectra of CO produced from the MEA-¹²CO₂ electrolysis (pattern of ¹²CO (M/Z=28)), with the electrolyte being purged with Ar before and during the reaction to remove any dissolved CO₂.

FIG. 14 includes a graph of H₂ production with an anode comprising Cu, carbon paper or carbon black (CB) as catalyst on PTFE in a 2 M MEA/2 M KCl electrolyte at different applied potentials, the generated H₂ being detected as the major product for all three control catalysts, with carbon black on PTFE showing only a background level of current density, <100 μA, and the generated gas product being below the detection limit of gas chromatography.

FIG. 15 includes two graphs illustrating potential j-V curves of a glass carbon electrode at different scan rates: Graph 15(a) being for a 2M MEA electrolyte and Graph 15(b) being for a 2 M MEA/2 M KCl electrolyte; and a Graph 15(c) illustrating a linear plot of the non-Faradaic current vs. the scan rate for both electrolytes of Graphs 15(a) and 15(b) with the error bars indicating the standard deviation of I_{capacitance} from three independent measurements.

FIG. 16 includes Scheme 16(a) representing the chemical structures of a MEA, a carbamate ion, and an ethanolammonium ion; Graph 16(b) showing a ¹H NMR spectra of the MEA and MEA-CO₂ adducts diluted with D₂O containing trimethylsilylpropanoic acid standard; and Graph 16(c) showing a ¹³C NMR spectra of the MEA and MEA-CO₂ adducts diluted with D₂O, with the peak labelled with “●” being contributed by bicarbonate/carbonate ions, and all NMR resonance signal assignments being determined according to COSY and HMBC.

FIG. 17 includes two graphs showing 2D NMR spectra of MEA-CO₂ adducts: Graph 17(a) being a 2D COSY NMR spectra (¹H-¹H Correlation Spectroscopy) of the MEA-CO₂ adducts, with diagonal peaks corresponding to the chemical shifts in 1D ¹HNMR spectra, cross peaks, appearing off the diagonal, indicating ¹H-¹H coupling in an homonuclear molecule, and the labelled 1′ and 2′ (shown in FIG. 16) showing cross peaks, representing the peaks being assigned for one molecule (carbamate ion), and the cross peaks for 1″ and 2″ being attributed to the ethanolammonium ion; and Graph 16(b) showing the 2D HMBC NMR spectra (Heteronuclear Multiple Bond Correlation) of the MEA-CO₂ adducts, with the f1 axis being contributed by the ¹³CNMR spectra, and the f2 axis which lies along the ¹HNMR spectra, and the signal representing a separated proton-carbon correlation that the proton of 2′ is correlated to a carbon of carboxylic acid in carbamate ion.

FIG. 18 includes two graphs showing ¹H NMR spectra: Graph 18(a) being for the as-prepared MEA electrolyte; and Graph 18(b) being for the saturated CO₂ electrolytes with 2 M of different cations.

FIG. 19 is a graph of the Faradaic efficiency of conversion into CO in MEA electrolytes with different alkali cations, with all cation concentrations being 2 M, and the error bars representing the standard deviation of three independent measurements.

FIG. 20 is a graph of the Faradaic efficiency of conversion into CO in for MEA electrolytes with different anions, with the concentrations being 2 M of potassium chloride (CV), potassium bicarbonate (HCO₃⁻) and potassium acetate (CH₃COO⁻), and the error bars representing the standard deviation of three independent measurements.

FIG. 21 illustrates an In-situ surface-enhanced Raman spectra of the CO_{ads} frequency for different electrolytes including 2 M of MEA and 2 M of different cations, with all potentials being applied with respect to the Ag/AgCl reference electrode: Graph 21(a) being for MEAH⁺, Graph 21(b) being for Li⁺, Graph 21(c) being for Na⁺, Graph 21(d) being for K⁺, Graph 21(e) being for Rb⁺ and Graph 21(f) being for Cs⁺, with the atop-bounded CO_{ads} vibration frequencies being used to calculate the Stark tuning slope in Graph 4(b).

FIG. 22 includes two graphs illustrating electrochemical performances for different temperatures: Graph 22(a) shows a j-V curve for different temperatures, ranging from room temperature to 80° C. for a 2 M MEA with 2 M KCl electrolyte, with the error bars representing the standard deviation of potentials from three independent measurements; and Graph 22(b) shows the product distribution of the MEA-CO₂ conversion to CO for temperatures ranging from 40° C. to 80° C. for the 2 M MEA/2 M KCl electrolyte, with the error bars representing the standard deviation of three independent measurements.

FIG. 23 is a graph showing product distribution of the MEA-CO₂ conversion to CO according to a cycling performance of the 2 M MEA/3 M KCl electrolyte at 10 mA/cm² applied constant current density, heated to 30° C. in a three-electrode configuration, with the CO faradaic efficiency being measured during operation over 10 hours for each cycle, and the remaining Faradaic efficiency being for H₂.

FIG. 24 is a graph of the product distribution of the MEA-CO₂ conversion to CO over time showing long-term stability of a 2M MEA/2M KCl electrolyte at 50 mA/cm² applied constant current density at room temperature in a flow cell configuration with 4 cm² active area, with the remaining FE being H₂.

FIG. 25 includes six graphs of NMR spectra for regeneration of MEA-CO₂: Graph 25(a) shows the ¹H NMR spectra of the MEA, MEA-CO₂ adducts, and thermally regenerated MEA, at 120° C. for 20 min and 60 min, with the carbamate NMR signals at 3.15 ppm and 3.6 ppm gradually disappearing due to heating and lost of CO₂, and the ethanolammonium signals at 3.09 ppm and 3.8 ppm gradually up-shifting back to the MEA; Graph 25(b) shows the ¹³C NMR spectra of the MEA-CO₂ adducts; Graph 25(c) shows the ¹H NMR spectra of the MEA and post-electrolysis of MEA electrolyte at applied current density 10 mA/cm² for 10 hours in a three-cell electrode system at room temperature; Graph 25(d) shows the ¹³C NMR spectra of the MEA and post-electrolysis of MEA electrolyte; Graph 25(e) shows the ¹H NMR spectra of the MEA and MEA/KCl electrolyte regenerated by electrochemical reaction, with the electrolysis being conducted at applied current density 50 mA/cm² for 10 hours in a flow cell system at room temperature, and the ethanolammonium signals up-shifting back to the MEA; and Graph 25(f) shows the ¹³C NMR spectra of the MEA/KCl and post-electrolysis of MEA/KCl electrolyte.

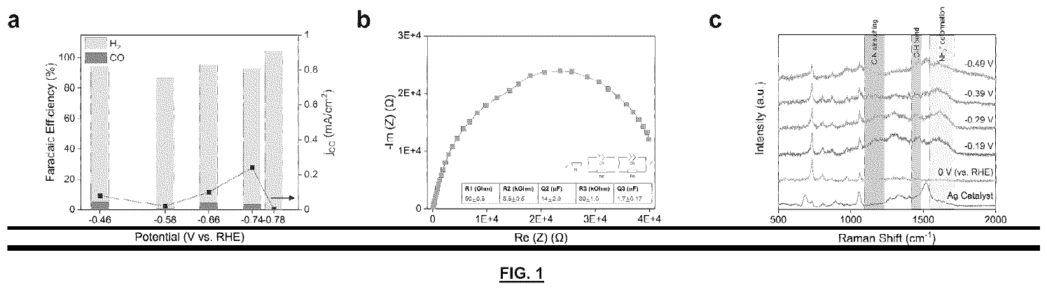

### DETAILED DESCRIPTION

Amine-based chemical solvents capture CO₂ at a point source and convert it into chemisorbed form. Pure CO₂ gas can then be generated from the capture solution by heating the solution to 120-150° C. The subsequent electrochemical upgrade of this CO₂ to value-added products, such as fuels and chemical feedstocks, requires additional energy inputs and processing.

A direct approach to electrochemically convert the chemisorbed CO₂ in the capture solution into reduced chemical products could be powered using renewable energy, and could simplify the process flow.

Amine solutions capture CO₂ via reaction:

2RNH₂+CO₂→RNHCOO⁻+RNH₃⁺ (1)

where the nucleophilic N and electrophilic carbon form a bond.

Several factors are necessary for the direct valorization of CO₂ in the RNHCOO⁻ via electrochemical reduction. First, the electrical energy required to break the N—C bond will scale proportionately with the strength of the CO₂ binding to the amine solution. Thus, the choice of the amine electrolyte will affect the overpotential of the electrocatalytic reactions. Second, the concentration as well as the diffusivity of RNHCOO⁻ will affect mass transport of the reactants. A low concentration of the amine solution leads to competing reactions such as the hydrogen evolution reaction. Finally, since heterogeneous electron transfer is an inner sphere reaction, the distance between RNHCOO⁻ and the electrode can play a role in the electrolysis reaction. The binding strength of the amine, the concentration, the supporting electrolyte and the reaction conditions are parameters that can be controlled to design an electrochemical system that can achieve the direct electrolysis of the amine-CO₂ adduct to value-added products, as well as the electrochemical regeneration of the amine solution.

Using an electrochemically-generated nucleophile, prior research has achieved CO₂ capture and its subsequently controlled release using quinone, bipyridine, thiolate molecules and transition metal complexes. CO₂ desorption from amine capture solutions has also been achieved using an electrochemically generated redox mediator. CO₂ electrolysis in aqueous monoethanolamine (MEA) solution was reported by Chen L, et al. Electrochemical Reduction of Carbon Dioxide in a Monoethanolamine Capture Medium. ChemSusChem 10, 4109-4118 (2017), where the authors provided that the carbamate (MEACOO⁻) and ethanolammonium ions (MEAH⁺) serve as the supporting electrolyte, but the carbon source is the dissolved CO₂. Khurram A, et al., Tailoring the Discharge Reaction in Li—CO₂ Batteries through Incorporation of CO₂ Capture Chemistry. Joule 2, 2649-2666 (2018), reported the direct electrolysis of amine-CO₂ to carbonate salts on a non-aqueous electrolyte. Khurram A, et al., Promoting Amine-Activated Electrochemical CO₂ Conversion with Alkali Salts. J. Phys. Chem. C 123, 18222-18231 (2019), also reported the influence of the different cation salts on the speciation of the amine-CO₂ adduct, and the change in the electrochemical rates due to the different species in the electrolyte.

Yet, even with these major studies, the field has yet to report electrolysis to higher value products from the amine-CO₂ adduct at greater than 50 mA/cm² operating current densities with high conversion efficiency to CO.

The direct electrolysis of the chemisorbed amine-CO₂ is proposed herein by tailoring the electrochemical double layer (EDL) using alkali cations. It is shown that, when alkali cations are introduced in amine-CO₂ electrolyte, they alter the composition of the electrochemical double layer in a way that facilitates the heterogeneous electron transfer to carbamate. This finding is supported using electrochemical impedance spectroscopy (EIS) and in-situ surface-enhanced Raman spectroscopy (SERS). In some implementations, under optimized conditions, a 72% Faradaic efficiency (FE) of CO₂-to-CO is achieved at applied current density 50 mA/cm². A successful recycling of the amine electrolyte with consistent CO FE is demonstrated over the course of multiple cycles of capture-electrolysis.

### The Electrochemical Double Layer in Amine-CO₂ Systems

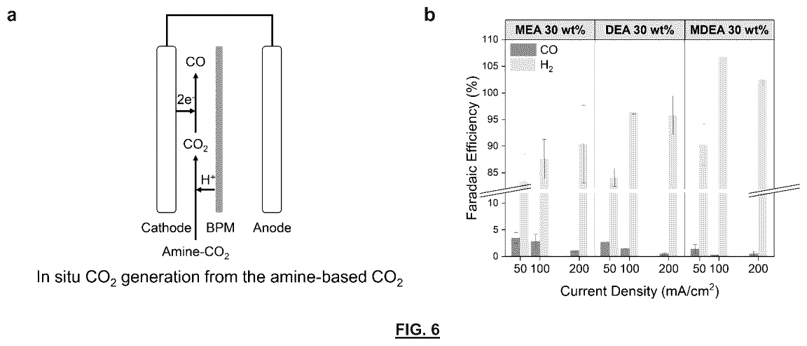

From a system design perspective, CO₂ can be released from amine capture solution via in situ-generated H⁺ from a bipolar membrane to achieve direct electrolysis. This concept is demonstrated herein with a 30 wt % aqueous MEA electrolyte at different applied current densities ranging from 50-200 mA/cm² (FIG. 6). The MEA electrolyte is first purged with CO₂ to form the MEA-CO₂ adduct, and then purged with N₂ to remove dissolved CO₂ to exclude the possibility of its reduction. The CO Faradaic efficiency is below 5% at all current densities tested and for the amine-CO₂ electrolytes studied (monoethanolamine-CO₂, diethanolamine-CO₂ and N-methyldiethanolamine-CO₂). The low FE is due to the utilization rate of the in situ-generated CO₂: unreacted CO₂ returns to the MEA-CO₂ adduct, and the local concentration of CO₂ on the surface of the catalyst is not high enough.

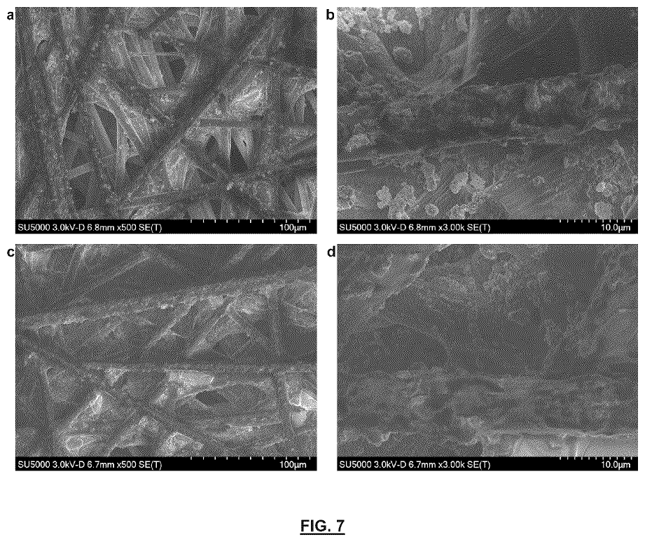

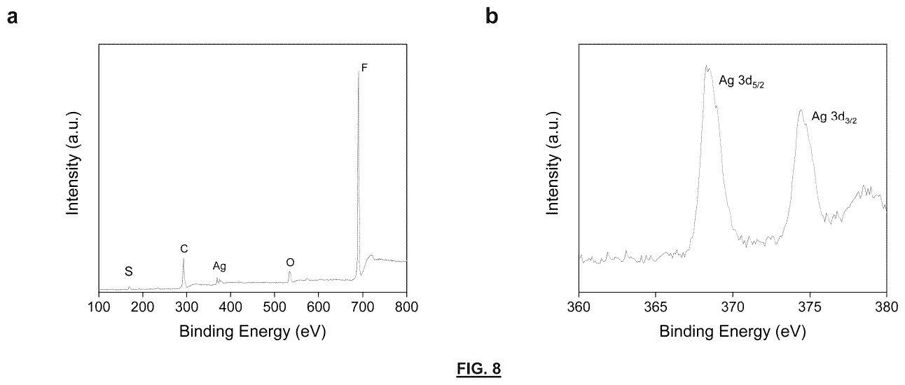

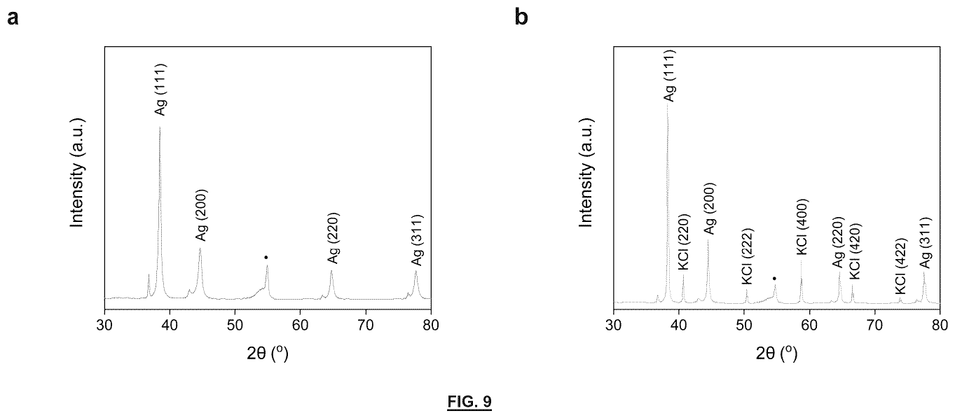

The direct electrolysis of the MEA-CO₂ adduct offers an approach that circumvents the limitation of the low solubility of CO₂. Direct electrolysis is pursued using an Ag electrocatalyst as the cathode in an amine-CO₂ electrolyte. The Ag electrocatalyst is prepared according to the procedures noted in catalyst preparation of the Methods section and is characterized by SEM, XPS and XRD to reveal morphology and surface composition (FIGS. 7-9). Both three-electrode systems and flow cell systems were studied. Pt foil and a 3 M Ag/AgCl electrode were used as the anode electrode and reference electrode respectively, separated by a Nafion membrane for ion migration. The catholyte in all studies is purged with CO₂ to form MEA-CO₂, after which N2 is purged for a minimum of 20 min to remove dissolved CO₂ (Supplementary Table 6) to confirm that MEA-CO₂ is a reactant. Upon absorption of the CO₂ molecule, MEA turns into ethanolammonium ion and carbamate, and these serve as the supporting electrolyte and the reactant. All potentials in this study are referenced to the RHE scale unless otherwise noted.

Graph 1a shows the FE of a 2 M MEA only electrolyte and the CO FEs are below 5% for all the potentials tested. The low FE was assumed to arise due to the inefficiency of electron transfer between the electrode and the carbamate molecule. Electrochemical impedance spectroscopy and in-situ surface-enhanced Raman spectroscopy were conducted to investigate electron transfer between the surface and species in the electrochemical double layer.

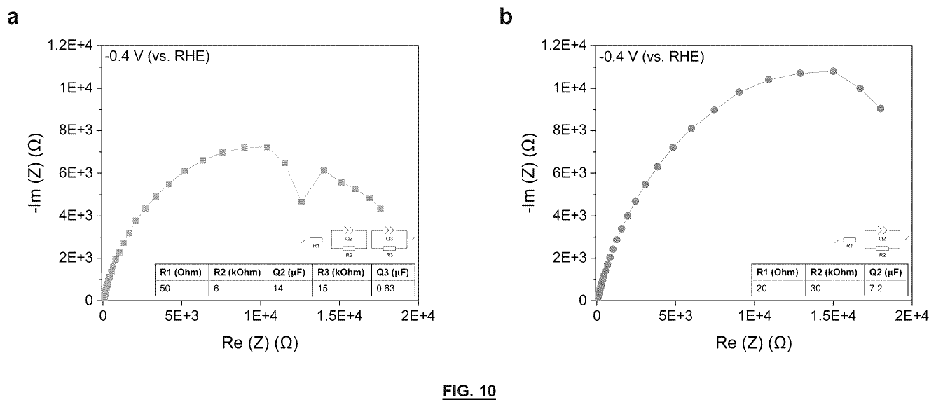

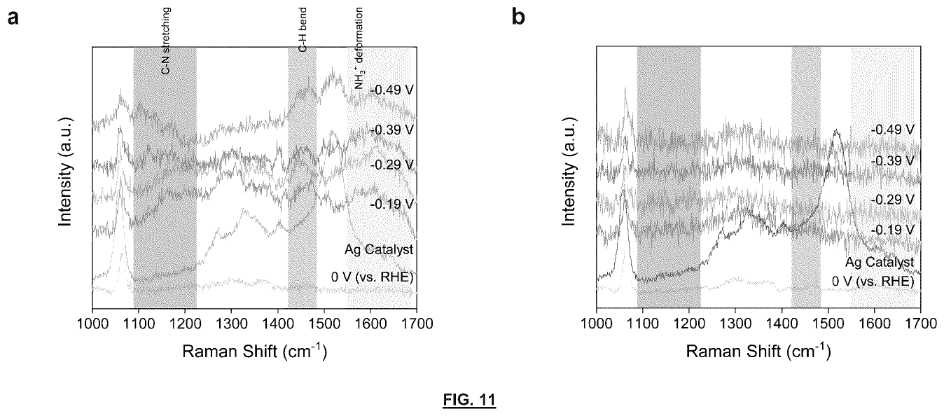

EIS spectra (Graph 1b) for the MEA electrolyte under open circuit conditions have two distinct semi-circles, indicating two charge transfer processes. The equivalent circuit shown in the inset of Graph 1b is fit using as two interfacial charge transfer resistances (R2, R3) each coupled with a double layer capacitance (Q2, Q3 which are also known as constant phase elements). In light of the frequency range tested herein from 10⁵ Hz to Hz, the equivalent circuit represents only charge transfer processes, and not a diffusion-limited process. The corresponding fits of the capacitance for each of the semi-circles differ by 14 μF and 1.7 μF, consistent with two distinct charge transfer processes. The two processes are observed in the frequency range 10 Hz to 100 Hz and 1 Hz to 0.1 Hz. Each frequency range is consistent with the timescale of a charge transfer reaction. In the MEA electrolyte, ethanolammonium and carbamate are the only ionic species capable of forming the EDL. Thus, the cationic ethanolammonium ion should occupy the inner Helmholtz layer, and the high frequency arc of the EIS spectra correspond to the EDL charging action of the ethanolammonium ion. The low frequency arc of the EIS spectra correspond to charge transfer to the carbamate molecule—the reaction step. Since H₂ is an observed reaction product, the low frequency arc of the EIS spectra could also correspond to charge transfer process to H₂O. Nonetheless, Graph 1b shows the ethanolammonium ion in the EDL and a charge transfer process corresponding to charge transfer from the inner Helmholtz layer to the outer Helmholtz layer. EIS measurements were conducted under negative polarization to examine further the EDL structure at the interface (FIG. 10). The EIS spectra show similar behavior to the OCP condition: for the MEA electrolyte there are two semi-circles indicating two interfacial structures. The result suggests the cationic ethanolammonium ion forms the inner Helmholtz layer due to the negatively biased surface and two different electron transfer occurs.

To probe further the electrode:electrolyte interface, in-situ surface-enhanced Raman spectroscopy was performed to investigate the surface species under different applied potentials. In light of the complex molecular system with Nafion binder, MEA, ethanolammonium ion and carbamate molecules, the amine-CO₂ adduct spectrum was extracted by first identifying the peaks from the Nafion binder. Graph 1c (and see FIG. 11 for a zoom-in version) shows the Raman spectra at different potentials. The Ag catalyst spectrum corresponds to the catalyst with Nafion binding without electrolyte. The Nafion molecular vibrations span 600 cm⁻¹ to 1600 cm⁻¹, thus, reaction intermediate species in this region are not considered. In the region where the Nafion peaks are absent, the spectrum appearing between 1100 cm⁻¹ to 1200 cm⁻¹ was assigned to the C—N stretching mode of the ethanolammonium ion in the electrolyte. 23-26 The peak at 1604 cm⁻¹ is assigned to the deformation mode of the ammonium cation (NH₃⁺) in the ethanolammonium ion on the Ag surface. The signal broadens and diminishes beyond −0.49 V (vs. RHE) as a result of the H₂ gas bubbles. The spectroscopic results suggest the adsorption of an organocation on the electrode surface.

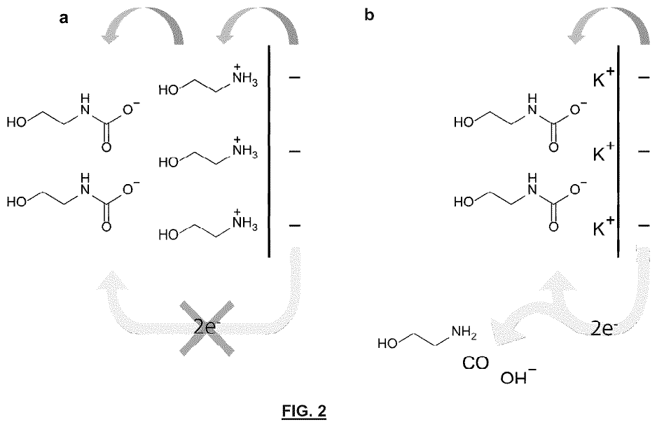

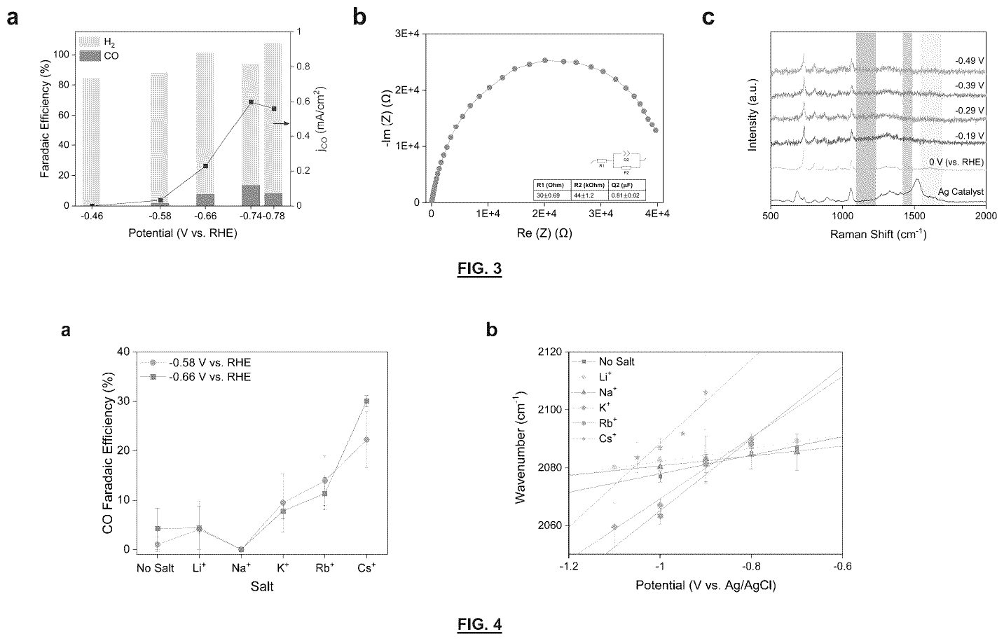

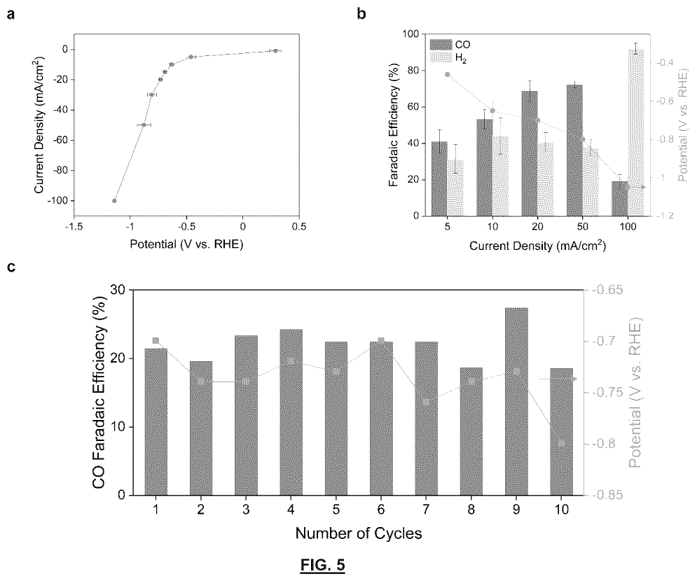

Taken together, the EIS and in-situ Raman studies suggest an interfacial electron transfer mechanism illustrated in FIG. 2a. In the pure MEA electrolyte, as ethanolammonium is the sole cation in the electrolyte, it forms the primary electrochemical double layer under negative bias conditions. The orientation or the conformation of the EDL may vary under different negative bias conditions; yet even so, electron transfer must first go through the ethanolammonium before reaching carbamate due to the length of the molecular chain—consistent with observations in the EIS spectra.

These observations led to studying the composition of the electrochemical double layer and its effect on electron transfer dynamics. Theoretical and experimental studies have proposed means by which the activity and selectivity of the CO₂ reduction reaction (CO₂RR) and the oxygen reduction reaction (ORR) are affected by the adsorbates in the Helmholtz layer, and the adsorbates influence the reaction dynamics by positioning the reactants relative to the interface as seen in Khurram A, Yan L, Yin Y, Zhao L, Gallant B M. Promoting Amine-Activated Electrochemical CO₂ Conversion with Alkali Salts. J. Phys. Chem. C 123, 18222-18231 (2019); Gunathunge C M, Ovalle V J, Waegele M M. Probing promoting effects of alkali cations on the reduction of CO at the aqueous electrolyte/copper interface. Phys. Chem. Chem. Phys. 19, 30166-30172 (2017); Strmcnik D, et al. Effects of Li+, K+, and Ba2+ Cations on the ORR at Model and High Surface Area Pt and Au Surfaces in Alkaline Solutions. J. Phys. Chem. Lett. 2, 2733-2736 (2011); Thorson M R, Siil K I, Kenis P J A. Effect of Cations on the Electrochemical Conversion of CO2 to CO. J. Electrochem. Soc. 160, F69-F74 (2013); Resasco J, et al. Promoter Effects of Alkali Metal Cations on the Electrochemical Reduction of Carbon Dioxide. J. Am. Chem. Soc 139, 11277-11287 (2017); Li J, Li X, Gunathunge C M, Waegele M M. Hydrogen bonding steers the product selectivity of electrocatalytic CO reduction. Proc. Natl. Acad. Sci. 116, 9220-9229 (2019); McCrum I T, Hickner M A, Janik M J. Quaternary Ammonium Cation Specific Adsorption on Platinum Electrodes: A Combined Experimental and Density Functional Theory Study. J. Electrochem. Soc. 165, F114-F121 (2018); Strmcnik D, Kodama K, van der Vliet D, Greeley J, Stamenkovic V R, Marković N M. The role of non-covalent interactions in electrocatalytic fuel-cell reactions on platinum. Nat. Chem 1, 466-472 (2009); Pérez-Gallent E, Marcandalli G, Figueiredo M C, Calle-Vallejo F, Koper M T M. Structure- and Potential-Dependent Cation Effects on CO Reduction at Copper Single-Crystal Electrodes. J. Am. Chem. Soc 139, 16412-16419 (2017). These studies show that the steric properties of the adsorbates represent a factor that variously hinders or promotes the interaction of surface species with the catalyst.

Systematic tuning of the electrochemical double layer, through the introduction of properly sized electrolyte ions, therefore has the potential to provide an added degree of freedom to disrupt the undesired charge-blocking layer and achieve electron transfer to carbamate, and thus direct electrolysis.

FIG. 2b presents an electrochemical system designed for the direct electrochemical conversion of amine-CO₂ with the aid of alkali cations.

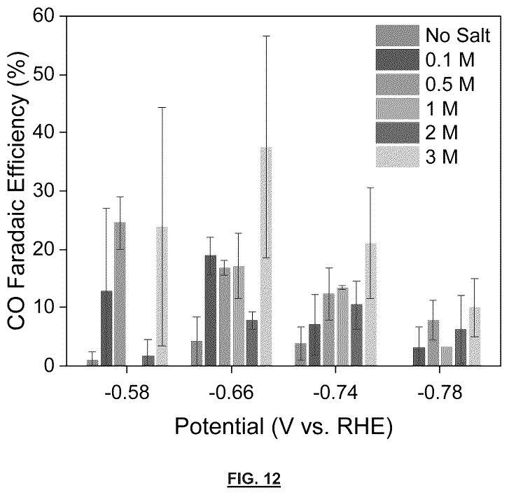

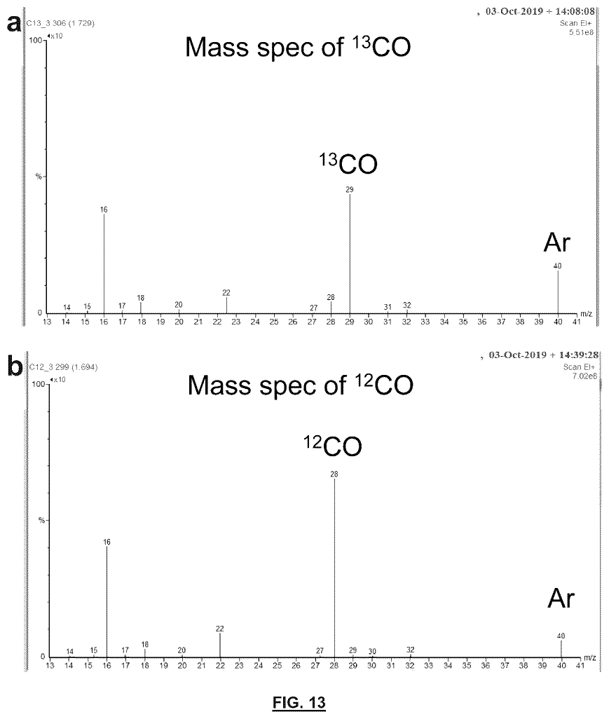

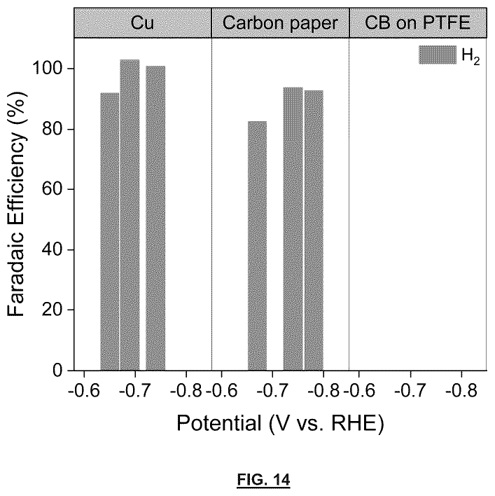

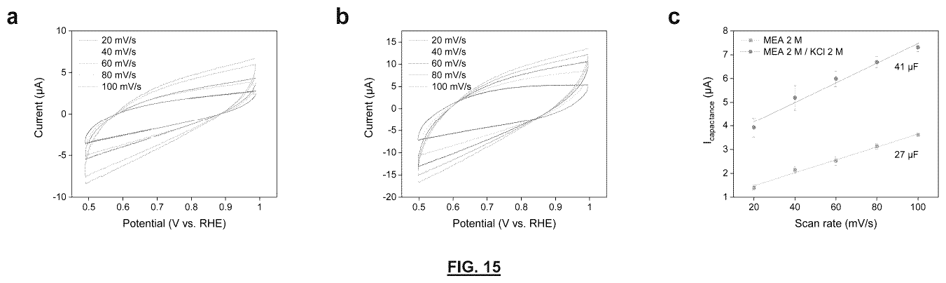

Beginning with potassium, Graph 3a shows the product distribution of amine-CO₂ electrolysis for a 2 M MEA/2 M KCl electrolyte. More particularly, Graph 3a exhibits improved CO₂RR FE compared to pure MEA electrolyte (Graph 1a), suggesting that the direct conversion of amine-CO₂ to CO was improved upon the introduction of the cation. The electrochemical performance was demonstrated with different ratios of supporting electrolyte from 0.1 M to 3 M (FIG. 12). Using isotopically labelled ¹³CO₂ (FIG. 13), the products observed in these reactions were determined to come from CO₂ captured by MEA. The isotope studies ruled out any chemical decomposition that could lead to false product detection. Possible substrate effects were further investigated by conducting control experiments with a carbon electrode, in which it was found that carbon-based electrocatalysts produced only H₂ and did so only at a background level of current density ˜100 μA (FIG. 14). In Graph 3b, the EIS spectra of the MEA/KCl electrolyte shows only one semi-circle feature throughout the frequency range tested. Thus, the equivalent circuit shown in the inset of Graph 3b is fit as a charge transfer process coupled with R2 (charge transfer resistance) and Q2 (the constant phase element). The EIS spectra indicates an interfacial structure that is distinct from that of the pure MEA electrolyte. The Raman spectra acquired with the MEA/KCl electrolyte (Graph 3c and Graph 11b) show that the peak features between 1100 cm⁻¹ and 1700 cm⁻¹, corresponding to the MEA, ethanolammnium ion and carbamate molecules, have substantially disappeared, suggesting that it is no longer the dominant surface species. The surface electrochemical double layer capacitances for a MEA vs. MEA/KCl electrolyte (FIG. 15) show that use of the K⁺ ion leads to a more compact double layer on the electrode surface compared to the case of ethanolamonium cation, in agreement with the view that the molecular size of the ethanolammonium cation is larger than that of the hydrated K⁺ in the electrochemical double layer. More particularly, referring to Graph 15(c), the electrochemical double layer capacitance for the electrolyte with K⁺ cation is seen higher than for the MEA electrolyte. Since the electrode surface area is the same, the surface ion concentration is higher with the addition of the K⁺ and it can be indicative that the molecular size of the ethanolammonium cation is larger than the hydrated K⁺, thereby hindering the electron transfer process.

Taken together, the electrochemical and spectroscopic studies suggest that in pure MEA, the ethanolammonium ion is the only cationic species in the electrolyte, and thus forms a monolayer on the reducing electrode surface, accounting to the sharp molecular features in the Raman spectra (Graph 1c). For the MEA/KCl electrolyte, the K⁺ ion competes for surface binding sites and replaces the ethanolammonium ion. The direct electrochemical conversion of amine-CO₂ based on tailoring the electrochemical double layer with the aid of a suitably sized cation is then achieved according to Eq 2:

RNHCOO⁻+2H⁺+2e⁻→RNH₂+CO+OH⁻ (2)

### Tailoring the Double Layer Using Alkali Cations

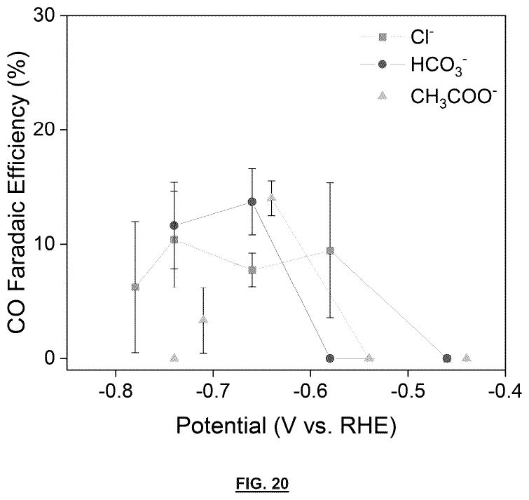

Different alkali cations (Li⁺, Na⁺, K⁺, Rb⁺ and Cs⁺) were further examined to gain insight into how the size of the cationic species affects the electrochemical double layer and the reduction of the MEA-CO₂ adduct. Different cation species were compared by adding 2 M of the respective salt to the MEA electrolyte at applied potentials of −0.58 V and −0.66 V vs. RHE, shown in Graph 4a. A wider potential range of the CO FE, from −0.46 V to −0.78 V vs. RHE, is shown in FIG. 19. The CO FEs for the Li⁺ and Na⁺ electrolyte are similar to those of the 2 M MEA electrolyte, which is below 5%. Cs⁺ electrolyte shows the best performance, with 30% CO FE at −0.66 V vs. RHE. Cs⁺ has the smallest hydrated ionic radius, whereas Li⁺ has the largest due to the difference in water coordination. The abrupt changes in CO FE argue against the possibility that the cation serves to improve the adsorption energy of reactants by increasing the strength of electric field. Prior studies observed a gradual increase in product conversion efficiency as the cationic size increased; whereas, herein, the product was not detected in the case of MEAH⁺, Li⁺ and Na⁺. A cation effect was considered as potentially buffering local pH on the cathode surface to maintain the CO₂ concentration; however, the reactant in the present system is in the molar range, and this is sufficient for reaction without need of buffering. The effects of different anions were further examined in the electrolyte and it was found that the electrochemical performance was similar for the different anions tested (Cl⁻, HCO₃⁻ and CH₃COO⁻) (FIG. 20). These electrochemical observations are consistent with a picture of the interfacial structure (FIG. 2) wherein the electrochemical double layer at the cathode consists largely of cationic species, and the anionic species have a minimal effect on electron transfer within the Helmholtz layer. Hydrogen evolution is relatively unaffected by the cation size, and thus the differences in the electrochemical performance arise primary from the change in the interfacial structure.

In order to explore further how tailoring the electrochemical layer by cationic species affects the electron transfer, the interfacial electric field strength was investigated via the Stark tuning. The vibration frequency associated with surface intermediates, such as CO_{ads}, depends on the applied potential. Furthermore, the slope of the frequency shift depends on the local electric field strength, which allows a direct reflection of the interfacial electric field with respect to the cationic species.

ν(ϕ)=ν₀−Δ\vec{μ}·\vec{E}(ϕ) (3)

where ν(ϕ) is the vibration frequency of the adsorbed CO at the applied potential (ϕ), ν₀ is the vibration frequency without an applied potential and Δ\vec{μ} is the field-free dipole moment known as the Stark tuning rate, which can be independently determined by experiment and simulation for specific metal electrode and adsorbed molecules. \vec{E}(ϕ) is the potential-dependent interfacial electric field and the gradient of potential (\vec{E}(ϕ)=−∀ϕ). Therefore, the slope of frequency shift of CO_{ads} with respect to applied potential can be expressed as the derivative of electric field:

$$\frac{d v}{d ϕ} = - Δµ \frac{d E}{d ϕ} \qquad ( 4 )$$

This electric field strength can be correlated with the thickness of Helmholtz layer because the electrochemical double layer can be modeled as a parallel-plate capacitor in the Helmholtz model.

Graph 4b and Table 1 show the CO_{ads} frequency shift for the MEA electrolyte with and without alkali cations. The Stark tuning slopes for K⁺, Rb⁺ and Cs⁺ are significantly larger than MEAH⁺, Li⁺ and Na⁺ which agrees with the picture that the thickness of the electrochemical layer for K⁺, Rb⁺ and Cs⁺ is lower than that of MEAH⁺, Li⁺ and Na⁺. The agreement between the experimental results and proposed interfacial structure supports the contention that the introduction of different cations is capable of improving the electron transfer from the electrode to the chemisorbed CO₂ and enable the direct electrolysis of amine-CO₂.

TABLE 1
Electrochemical Stark tuning slopes from linearly-fit lines with different
cations. The error bars correspond to the standard deviation of Stark
tuning slopes from three independent measurements.

| Cation | MEAH⁺ | Li⁺ | Na⁺ | K⁺ | Rb⁺ | Cs⁺ |
|---|---|---|---|---|---|---|
| Stark tuning slope | 32 ± 6 | 23 ± 3 | 17 ± 3 | 106 ± 10 | 125 ± 31 | 145 ± 4 |
| (V⁻¹cm⁻¹) | | | | | | |

### Electrochemical Regeneration of the Amine Capture Solution

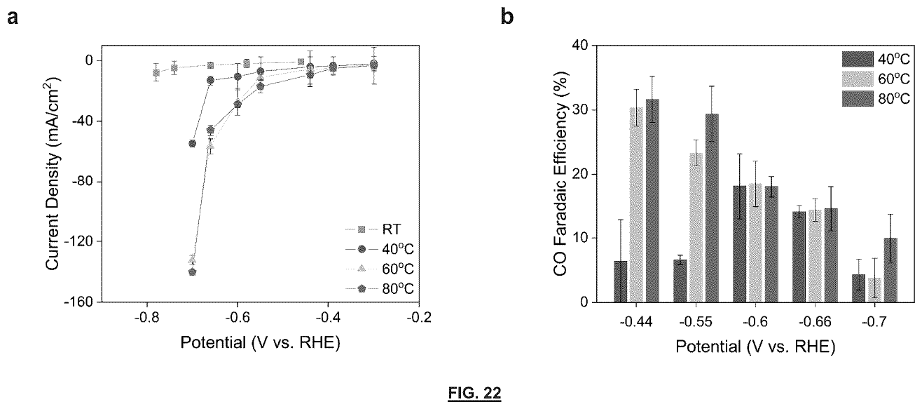

Because the reactant in this study is liquid amine-CO₂, the gaseous products, CO and H₂ are not diluted with unreacted CO₂ and offer a mixture of interest for the Fischer-Tropsch reaction. In order for electrolysis of amine-CO₂ to reach meaningful levels of utilization, the current density was sought to be improved and recyclability of the capture-electrolysis process was demonstrated. The catholyte was heated to 40° C.˜80° C. to facilitate the breaking of the N—C bond. This temperature range is consistent with typical water electrolyzer operating conditions and is significantly lower than the thermal regeneration temperature of an amine capture solution. The current density at 60° C. is 15× higher than at room temperature. CO FEs increase with temperature as well (FIG. 22). The increasing current density and the FE suggest that the products are generated from amine-CO₂ reactants, not dissolved CO₂. The amount of dissolved CO₂ is limited by low solubility in an aqueous electrolyte, therefore, the current density is curtailed by mass transport. Diffusion-limited current density for dissolved CO₂ was reported as ˜10 mA/cm² under different testing conditions. On the other hand, amine-CO₂ provides herein a concentration of ˜2.5 M. The large current density serves as a qualitative indication that the reactant has to come from amine-CO₂. In order to improve the electrochemical performance further, an Ag catalyst with added carbon black on PTFE was implemented to increase the local concentration of reactants. The catholyte, 30 wt % aqueous MEA solution with 2 M of KCl, was heated to 60° C., and the catholyte was circulated (electrochemical performances in the Methods section). Graph 5b shows the product distribution, CO and H₂, at different current density ranging from 5 mA/cm² to 100 mA/cm². The best CO FE is 72% at 50 mA/cm² and −0.8 V vs. RHE. As shown in Graph 5b, 100+ mA/cm² current density is achieved with high CO FE. These performance improvements are enabled by faster reactant transport and thermally assisted N—C bond cleavage.

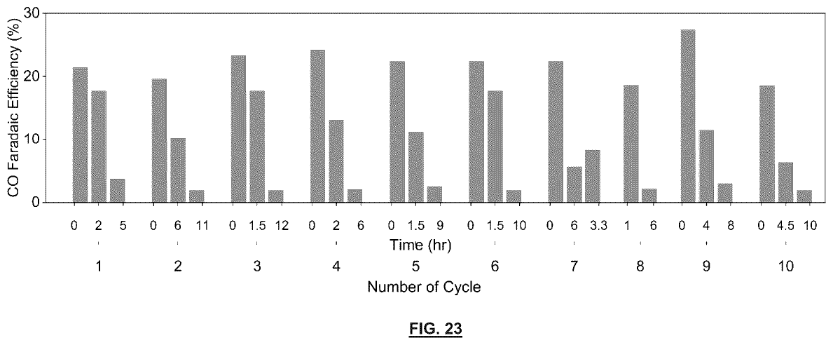

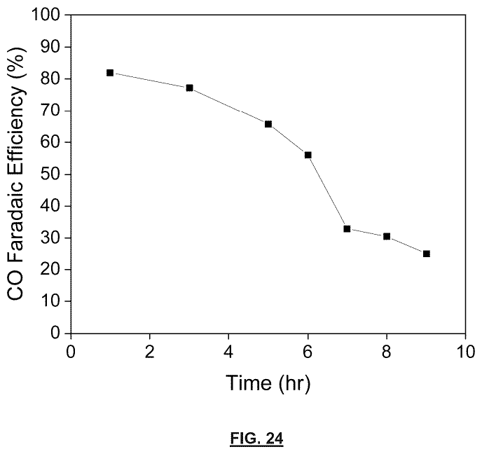

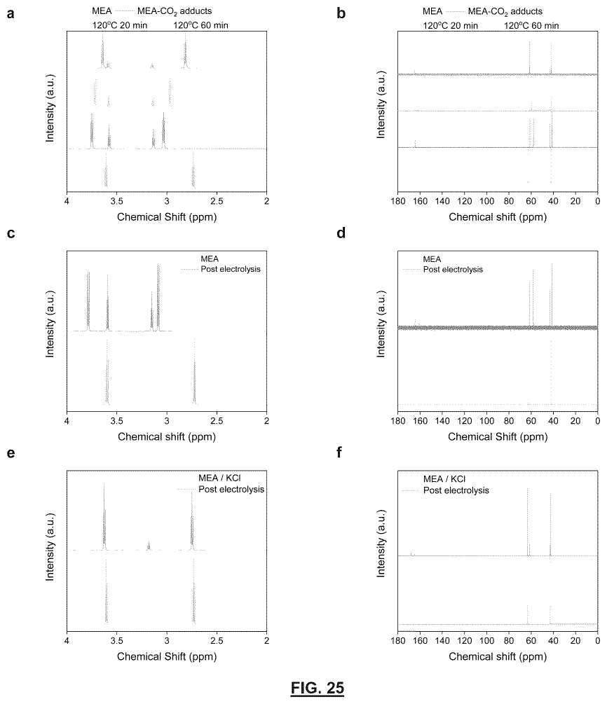

To explore recyclability of the electrolyte, a cycling test of the amine-CO₂ electrolysis process was performed. The amine-CO₂ electrolysis was first ran at a constant current density until the concentration of amine-CO₂ was depleted, a process that took 10 hours of operation. A decrease in FE during 10-hour operation is observed and is explained by the depletion of the concentration of chemisorbed CO₂ (FIGS. 23-24). For example, FIG. 24 shows that 18 mmol of CO₂ was consumed during a 10-hour electrolysis. When the reaction ends, the electrolyte is re-purged with CO₂ and a new cycle of electrolysis was then initiated. The pH values of the electrolyte were measured at different stages of CO₂ purging and electrolysis (Supplementary Table 8): less than 1 pH unit of drift was observed. Graph 5c demonstrates the cycling performance of the electrolyte when electrolysis is run at constant current density from CO₂ capture electrolyte. A consistent CO FE in performance was observed over 10 continuous cycles. Nuclear magnetic resonance spectra show the chemical structure of the carbamate after CO₂ purging and also the significant decrease of the carbamate signal at the end of a ten hour electrolysis (FIG. 25). Electrolysis persisted for 10 hours supports the contention that the reactant comes from amine-CO₂ in light of its sufficient quantity.

### Energy Analysis

To assess the prospects from a CO₂ reduction, the energy cost for different CO₂RR systems was calculated, and compared to the present amine-CO₂ system. More particularly, the compared systems were alkaline flow cells, gas-fed membrane electrode assembly cells, direct carbonate electrolysis and the present direct amine-CO₂ electrolysis. Table 2 summarizes the results and the details are provided in relation to Supplementary Tables 1 to 4. The total energy required to generate 1 mol of product from the direct chemisorbed CO₂ reduction system is comparable to the well-known CO₂RR systems. It was further estimated that the dollar cost for the regeneration of carbonate and crossed-over CO₂ (Supplementary Table 5). The economic analysis suggested that incomplete utilization will lead to a significant increase in total cost: this is in the range ˜170/ton of product for both MEA and flow cell systems studied in this example. This provides a sense of why amine-CO₂ systems are of interest: approaches that lever its ability to perform electrolysis directly from a capture liquid can reduce the energy cost (and carbon footprint) of the CO₂ capture process, as well as final product separation.

TABLE 2
Energy cost for an alkaline flow cell, gas-fed MEA cell, direct
carbonate electrolysis and direct amine-CO₂ electrolysis

| | Flow | | Direct | Direct |
|---|---|---|---|---|
| System | cell | MEA | CO₃²⁻ | amine-CO₂ |
| CO₂ utilization (%) | 17 | 35 | 100 | 90 |
| Carbonate formation | 45 | 0 | 0 | 10 |
| (%) | | | | |
| Crossover (%) | 2 | 30 | 0 | 0 |
| Exit CO₂ (%) | 36 | 35 | 0 | 0 |
| CO₂ regeneration | 206 | 100 | 0 | 0 |
| (kJ/mol of prod.) | | | | |
| Electrolysis | 485 | 643 | 2572 | 643 |
| (kJ/mol of prod.) | | | | |
| Product separation | 147 | 71 | 25 | 25 |
| (kJ/mol of prod.) | | | | |
| Total energy | 838 | 814 | 2597 | 668 |
| (kJ/mol of prod.) | | | | |
| Total energy | 30 | 29 | 93 | 24 |
| (kJ/ton of prod.) | | | | |

It was concluded that tuning the electrochemical double layer enables the direct electrolysis of amine-CO₂ to value-added products, and does so in a way that allows recycling of the amine solvent. Electrochemical studies and in-situ surface-enhanced Raman spectroscopy indicate that the adsorbed cations at the electrode surface influence electron transfer dynamics. It was found that different constituents of the electrochemical double layer can hinder or promote the heterogenous electron transfer, a finding that is attributed to the distance between the reactants and the electrode. With the aid of alkali cations, the direct electrolysis of the amine-CO₂ is achieved with 72% CO FE at 50 mA/cm². The cyclability of the amine-CO₂ electrolyte was also demonstrated. The electrochemical strategy highlighted in this study offers a route to the design of CO₂ capture-electrolysis processes that will lower the energy cost and simplify the process flow.

### Materials and Methods

Catalyst Preparation

All reagents used in the experiments were purchased from Sigma Aldrich without further purification. Ag catalysts were prepared by spray-coating Ag nanoparticle ink onto a sputtered Ag film. For the Ag film, Ag was sputtered on a carbon paper (AvCarb MGL190, Fuel Cell Store) using an Ag target at a sputtering rate of ˜1 Å/s to fabricate a 300-nm-thick Ag film. Ag nanoparticles (200 mg) were then dispersed in a mixture of 12.5 mL methanol and 400 uL Nafion and then sonicated for 1 hour. The Ag nanoparticle ink was spray-coated on the sputtered Ag with a loading of ˜5 mg/cm² and dried under atmospheric conditions. The Ag catalysts were used for electrochemical characterization in an H-Cell.

For flow cell systems, Ag/carbon black catalysts were prepared by spray-coating Ag nanoparticle with carbon black onto a sputtered Ag film. For the Ag film, Ag was sputtered on a PTFE substrate (450 nm pore size) using an Ag target at a sputtering rate of ˜1 Å/s to fabricate a 300-nm-thick Ag film. Ag nanoparticles (200 mg) were dispersed in a mixture of 12.5 mL methanol, 400 uL Nafion, and 50 mg carbon black (Super P Conductive, Alfa Aesar) and then sonicated for 1 hour. The Ag/carbon black nanoparticle ink was spray-coated on the sputtered Ag with a loading of ˜5 mg/cm² and dried under atmospheric conditions.

Electrochemical Performance

Electrochemical data were collected using an electrochemical station (PGSTAT204) in a three-electrode system and a flow cell system. All electrochemical data were collected under N₂ purging to remove dissolved CO₂ in the electrolyte. The as-prepared Ag catalyst was used as the working electrode in varying catholytes: 2 M aqueous solutions of MEA with or without supporting electrolyte. The anolyte was always a 1 M KOH solution. Pt foil and a 3 M Ag/AgCl were used as the anode electrode and reference electrode, respectively. Nafion 117 membrane was used to separate the two electrodes.

For the flow cell system, the as-prepared Ag/carbon black catalyst was used as the working electrode in the catholyte: 30 wt % of MEA plus 70 wt % of H₂O with 2M of KCl and 2M aqueous solutions of MEA with 2 M of KCl. The anolyte was always a 1 M KOH solution. Ni foam and 3 M Ag/AgCl were used as the anode electrode and reference electrode, respectively. Nafion 117 membrane was used to separate the cathode and the anode. The catholyte and anolyte were circulated using a peristaltic pump.

All potentials were applied against the Ag/AgCl reference electrode and then converted to the iR-corrected RHE scale using the following equation:

E_{RHE}=E_{Ag/AgCl}+0.21 V+0.059×pH−iR

The series resistance of the system was determined by electrochemical impedance spectroscopy.

The gas phase products were analyzed using gas chromatography (Perkin Elmer Clarus 580) equipped with a thermal conductivity detector (TCD) and a flame ionization detector (FID). All measurements were repeated three times to report the average and standard error.

Electrochemical impedance spectroscopy of the MEA and MEA/KCl electrolytes was conducted in the frequency range of 10⁵ Hz to 0.01 Hz at the open circuit potential and at −0.4 V RHE, using a glassy carbon electrode as the working electrode, Pt foil as the counter electrode, and Ag/AgCl as the reference electrode. The experiment was conducted in a three-electrode configuration without membrane separation. The EIS spectra were fitted with an equivalent circuit in the EC-Lab software.

Scan rate vs. capacitive current data was obtained from cyclic voltammograms at the potential range from −0.2 V to 0.3 V vs. Ag/AgCl in a three-cell electrode system, using a glassy carbon electrode as the working electrode, Pt foil as the counter electrode, and Ag/AgCl as the reference electrode. The double-layer capacitance was determined from the slope of non-Faradaic current vs. scan rate graph.

Characterization

The morphology of the Ag catalyst was characterized by field emission scanning electron microscopy (Hitachi, SU5000); X-ray diffraction (MiniFlex600) pattern was collected with Cu Kα as the radiation source. Surface composition was analyzed with ThermoFisher Scientific K-Alpha X-ray photoelectron spectroscopy using Al Kα X-ray radiation. XPS spectra were calibrated with the C 1s peak at 284.5 eV.

In-situ surface-enhanced Raman spectroscopy was conducted with a Renishaw in ViaRaman spectrometer using an in-house in-situ cell and a 50× water immersion lens. An Ag catalyst was used as the cathode in 2 M MEA or 2 M MEA/2 M KCl electrolytes purged with N₂ from the backside. Pt wire and Ag/AgCl were used as the anode and reference electrodes, respectively.

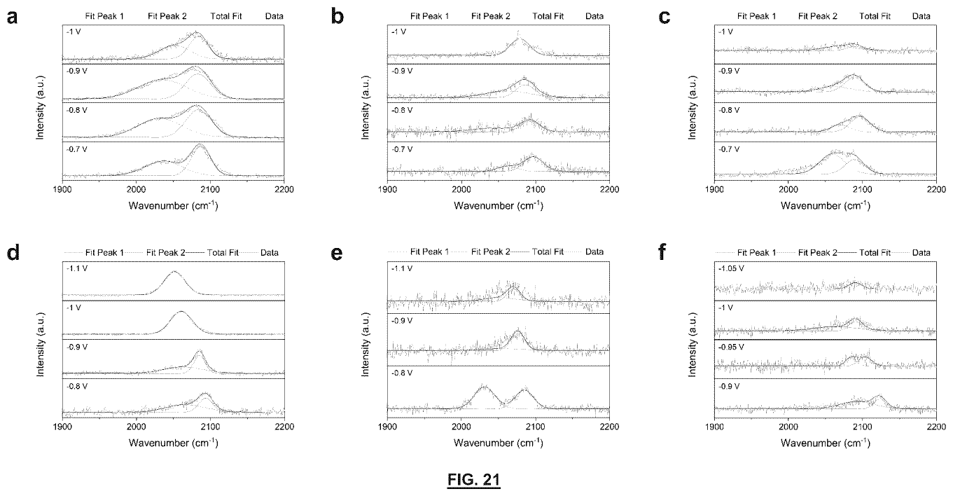

Stark effect was characterized by In-situ surface-enhanced Raman spectroscopy with a Renishaw in ViaRaman spectrometer using an in-house in-situ cell and a 50× water immersion lens. A Cu catalyst was used as the cathode to collect CO_{ads} vibrational mode in different electrolytes purged with CO₂ from the backside. Pt wire and Ag/AgCl were used as the anode and reference electrodes, respectively. A 2 M aqueous solution of MEA with or without alkali salts was used as the electrolyte. Different potentials, from −0.7 V to −1.1 V vs. Ag/AgCl, were held for 3 min before Raman experiments. All experiments were conducted by averaging three scans. Each scan shows the distinct CO vibrational signal between 2000 cm⁻¹ and 2100 cm⁻¹ which can be ascribed to CO adsorption on the bridge and atop sites. The bridge and atop CO vibration signals sometimes overlap due to difference in the local environment in the different testing conditions. Any signal with multiple peak shapes was deconvolved to two different spectra for the bridged and atop binding configurations. The vibration frequency for the atop configuration was used for the Stark tuning slope analysis. (FIG. 21)

Chemical structures of the electrolytes were analyzed with a 600 MHz Agilent DD2 ¹H NMR and ¹³C NMR spectrometer. All NMR samples were prepared in D₂O with a trimethylsilylpropanoic acid standard.

CO₂ Release

9 mL of 30 wt % aqueous MEA solution and 2 M of KCl aqueous solution were prepared and saturated with CO₂. A second solution with the same volume of 30 wt % MEA solution and 2 M of KCl aqueous solution was prepared and saturated with CO₂ but was then re-purged with N₂ for 20 min to remove any dissolved CO₂. Both solutions were heated at 70° C. for 15 min while collecting CO₂ release gas into a gas sampling bag. The volume of CO₂ release gas was measured by bubbling gas to an inverted graduated cylinder. The difference in gas collected is attributed to the dissolved CO₂ in the electrolyte.

Energy Analysis

The total energy cost of the direct MEA-CO₂ reduction was assessed with different well-known CO₂RR systems including an alkaline flow cell, a gas-fed membrane electrode assembly cell, and a direct carbonate reduction system. Each of the CO₂ conversion processes was assessed from gas-phase CO₂ capture, the upgrade into a targeted product, and final product separation, based on the reported data at similar current densities from the literature. The evaluation provides preliminary results to estimate the competitiveness of the direct MEA-CO₂ reduction process.

CO₂ Regeneration

To upgrade CO₂ into value-added products in the existing CO₂RR system, a pure gas-phase CO₂ stream needs to be generated from point sources. Here, the industrial CO₂ regeneration process from flue gas was considered as being amine scrubbing. Even though the CO₂ capture step with amine solvents is thermodynamically downhill, the regeneration of CO₂ requires significant energy inputs, typically by thermal and pressurization cycling processes. The energy cost for CO₂ regeneration from amine-CO₂ was reported by prior literature, and these are typically in the range of 28 kJ/mol to 35 kJ/mol of CO₂. Thus, for the flow cell and the MEA system, there is an energy cost for the CO₂ regeneration step to obtain a pure stream of CO₂ for electrolysis. In comparison, the direct valorization from the capture liquid—the direct carbonate and direct amine-CO₂ reduction—requires no heating step to regenerate CO₂. Therefore, the CO₂ regeneration energy cost is 0.

CO₂ Utilization

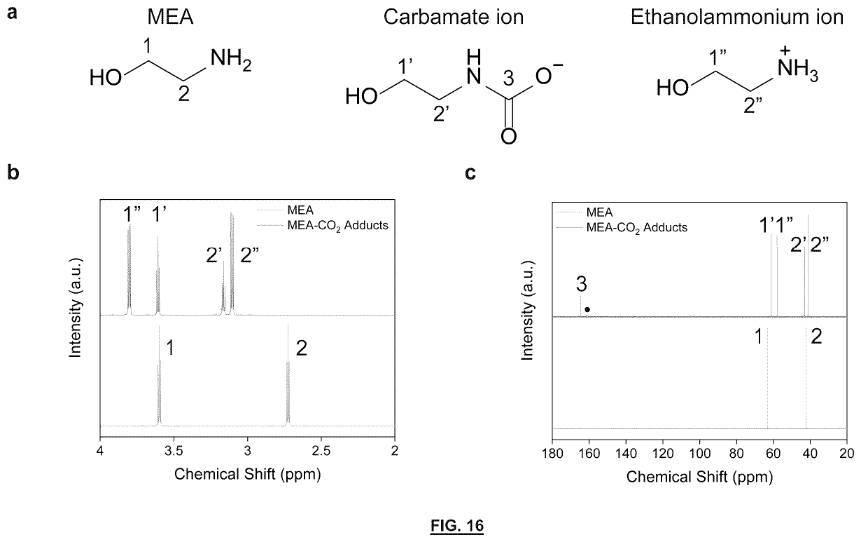

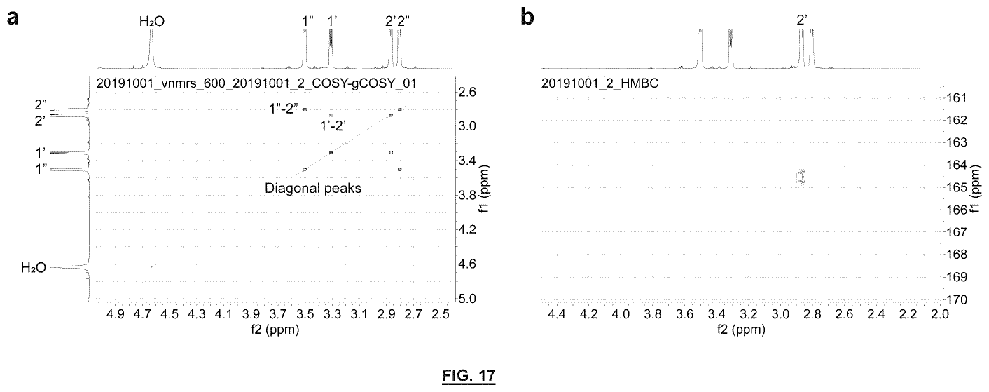

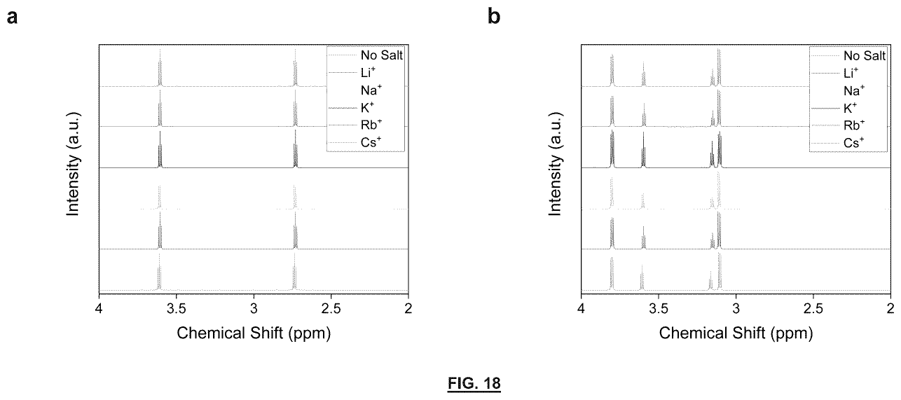

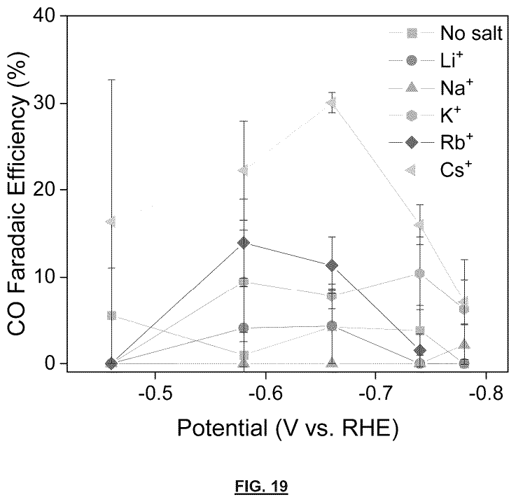

CO₂ utilization is defined here as the percentage of input carbon converted to targeted product. For the alkaline flow cell, CO₂ gas could be lost to the hydrolysis reaction with electrolyte, crossover to the anode and low single pass efficiency. Based on published literature, as much as ˜45% of CO₂ gas becomes carbonate/bicarbonate ion, 2% is lost due to crossover, and 36% of CO₂ is released unreacted at the exit. As a result, 6 moles of CO₂ are required to produce 1 mole of product. In the MEA cell, the system is free from carbonate formation due to the lack of liquid catholyte. However, bicarbonate ions from the humidified CO₂ can still lead to crossover when an anion exchange membrane is used. Such systems suffer a loss of ˜30% CO₂ based on previous simulation models. Also, a 35% loss to unreacted exit is assumed, similar to the flow cell. Thus, the MEA cell requires 3 moles of CO₂ to generate 1 mole of product. In the case of the direct amine-CO₂ electrolysis, the metric of CO₂ utilization for chemisorbed CO₂ is considered, as the dissolved CO₂ is removed by N2 purging. There is no crossover loss due to the use of the Nafion membrane, and no exit CO₂ was detected during the electrolysis. The small amount of bicarbonate is formed from CO₂ purging and carbamate transformation. The ¹³C NMR spectra in FIG. 16 show a small peak of bicarbonate/carbonate. The amount of CO₂ uptake to bicarbonate is estimated to be a 10% loss based on the peak area. The estimation agrees with prior experimental and computational studies. Thus, it is considered that 90% CO₂ utilization for this study. For the carbonate electrolysis, the CO₂ utilization is 100% due to the direct utilization of carbonate and a bipolar membrane. 8

Based on the evaluations of CO₂ utilization above, the energy cost required to produce 1 mole of product from the CO₂ regeneration process is calculated. The typical regeneration energy from flue gas is 35 kJ/mole of CO₂; therefore, 206 kJ/mole of product is needed for the flow cell system and 100 kJ/mole of product to generate the required CO₂ sources, respectively. In comparison, the direct carbonate and direct amine-CO₂ reduction requires no heating step to regenerate CO₂. Therefore, the CO₂ regeneration energy is 0.

$${CO}_{2} regneration energy = 35 \frac{kJ}{mol} \times \frac{1}{{CO}_{2} Utilization ( \% )}$$

SUPPLEMENTARY TABLE 1
Energy cost for CO₂ regeneration depending on
CO₂ utilization of the different CO₂RR systems

| | Flow | | Direct | Direct |
|---|---|---|---|---|
| System | cell | MEA | CO₃²⁻ | amine-CO₂ |
| CO₂ utilization (%) | 17 | 35 | 100 | 90 |
| Carbonate formation | 45 | 0 | 0 | 10 |
| (%) | | | | |
| Crossover (%) | 2 | 30 | 0 | 0 |
| Exit CO₂ (%) | 36 | 35 | 0 | 0 |
| Required CO₂ | 6 | 3 | 1 | 1 |
| (mol/mol of prod.) | | | | |
| CO₂ regeneration | 206 | 100 | 0 | 0 |
| (kJ/mol of prod.) | | | | |

Electrolysis

published energy efficiency (EE) for each electrolysis system and the theoretical Gibbs free energy for CO production is considered. Kenis et al. reported 53% energy efficiency for a flow cell system. In the case of a MEA cell, the record for energy efficiency is 40%. For both systems, an Ag-based electrocatalyst was used, showing over 90% FE. The energy efficiency for the direct carbonate system to CO is 10% from the literature. In the amine-CO₂ electrolysis reported here, the energy efficiency for CO is calculated according to the following equation:

$$E {E}_{full - cel1} = \frac{1.23 - {E}_{CO}}{1.23 + {η}_{OER} - {E}_{applied}} \times F {E}_{CO}$$

where E_{CO} (vs. RHE) is the thermodynamic potential of the CO₂ electroreduction to CO and E_{applied} (VS RHE) is the applied potential. A constant overpotential for the OER, η_{OER}=350 mV, with Ni foam catalyst in 1 M KOH. was assumed. The calculated energy efficiency for the amine-CO₂ electrolysis in this study is 40%.

From the energy efficiency of each system, the electrolysis energy cost was calculated according to the following equation:

$$Electrolysis energy = Δ {G}_{CO} ( \frac{kJ}{mole of CO} ) / Energy efficiency ( \% )$$

where ΔG_{CO} is Gibbs free energy of CO formation which is 257.2 kJ/mol.

In summary, the energy costs are 485 kJ/mol for the flow cell system, 643 kJ/mol for the MEA cell system, 2572 kJ/mol for direct carbonate reduction, and 643 kJ/mol for direct amine-CO₂ reduction, respectively.

SUPPLEMENTARY TABLE 2
Energy cost for CO₂ electrolysis for the different CO₂RR systems

| | Flow | | Direct | Direct |
|---|---|---|---|---|
| System | cell | MEA | CO₃²⁻ | amine-CO₂ |
| Energy | 53 | 40 | 10 | 40 |
| efficiency (%) | | | | |
| Electrolysis | 485 | 643 | 2572 | 643 |
| (kJ/mol of prod.) | | | | |

Product Separation

In this study, a fixed cost of 25 kJ/mol is used for product separation based on the pressure swing adsorption (PSA) process for CO₂ from syngas. The product separation cost is calculated according to the following equation:

$$Separation Energy = 25 ( \frac{kJ}{mole of gas} ) \times Total exit gas ( \frac{mol}{1 mol of product} )$$

The total exit gas is the total gas amount, in mol, exiting the reactor per mol of target product. Therefore, the separation energy cost increases as the mole fraction of target product decreases.

SUPPLEMENTARY TABLE 3
Energy cost for products separation
depending on different CO₂RR system.

| | Flow | | Direct | Direct |
|---|---|---|---|---|
| System | cell | MEA | CO₃²⁻ | amine-CO₂ |
| Product | 147 | 71 | 25 | 25 |
| separation | | | | |
| (kJ/mol of prod.) | | | | |

The energy cost for each step and the total energy cost was tabulated in Supplementary Table 4. The total energy cost per 1 kg of a target product for the amine-CO₂ system is the lowest at 23 kJ/tonne of CO. This preliminary result demonstrates that the direct upgrade of captured CO₂ could be as competitive as the existing CO₂RR systems and provides new directions for industrial applications in CO₂ conversion.

SUPPLEMENTARY TABLE 4
Total energy cost for the different CO₂RR systems.

| | Flow | | Direct | Direct |
|---|---|---|---|---|
| System | cell | MEA | CO₃²⁻ | amine-CO₂ |
| CO₂ regeneration | 206 | 100 | 0 | 0 |
| (kJ/mol of prod.) | | | | |
| Electrolysis | 485 | 643 | 2572 | 643 |
| (kJ/mol of prod.) | | | | |
| Product separation | 147 | 71 | 25 | 25 |
| (kJ/mol of prod.) | | | | |
| Total energy | 838 | 814 | 2597 | 668 |
| (kJ/mol of prod.) | | | | |
| Total energy | 29 | 29 | 91 | 23 |
| (kJ/tonne of prod.) | | | | |

Effective CO₂ Cost

In known CO₂RR systems (an alkaline flow cell and a gas-fed MEA cell), CO₂ is lost as carbonate formation with the catholyte and crossover to the anodic side. To accurately represent the CO₂ cost, the regeneration of carbonate back to CO₂ and the separation of crossed-over CO₂ from O₂ must be accounted after the electrolysis process.

The typical process to regenerate carbonate to CO₂ is a thermal calcium caustic recovery loop. The process will require 1232 kWh/ton of CO₂, and thus, the cost of carbonate regeneration is $36.4/tonne of CO₂ assuming that the cost of electricity is $0.03/kWh. Based on Supplementary Table 1, it was found that 3 moles of CO₂ are converted to carbonate for every CO₂ reduced to a product (4.15 tonne of CO₂/tonne of CO) in an alkaline flow cell, and 1 mol of CO₂ is lost for every 10 moles of CO₂ that are reduced to CO (0.17 tonne of CO₂/tonne of CO) in the amine-CO₂ system reported herein. The regeneration cost was calculated according to the following equation:

$$Regeneration cost = ( \frac{\$36 \text{.4}}{tonne of {CO}_{2}} ) \times carobnate generation ratio ( \frac{tonne of {CO}_{2}}{tonne of CO} )$$

For the CO₂ separation cost from O₂, a fixed cost of $70/tonne of CO₂ is used based on the existing capturing technology for flue gas. From Supplementary Table 1, 1 mol of CO₂ crosses over for every mol of CO₂ reduced (1.35 tonne of CO₂/tonne of CO) in a gas-fed MEA cell and the crossover ratio for a flow cell system is 0.18 tonne of CO₂/tonne of CO. The separation cost was calculated according to the following equation:

$$Separation cost = ( \frac{\$70}{tonne of {CO}_{2}} ) \times crossover ratio ( \frac{tonne of {CO}_{2}}{tonne of CO} )$$

Even though the cost of CO₂ is expected to be reduced to $50/tonne of CO₂ with improved process design, the CO₂ loss during the electrolysis step will lead to an approximately 2.5× increase in the effective CO₂ cost (Supplementary Table 5). In comparison, the conversion of amine-CO₂ is free from carbonate formation and crossover.

SUPPLEMENTARY TABLE 5
Total effective CO₂ cost for the different CO₂RR systems

| | Flow | | Direct | Direct |
|---|---|---|---|---|
| System | cell | MEA | CO₃²⁻ | amine-CO₂ |
| CO₂ utilization (%) | 17 | 35 | 100 | 90 |
| Carbonate formation | 45 | 0 | 0 | 10 |
| (%) | | | | |
| Crossover (%) | 2 | 30 | 0 | 0 |
| Exit CO₂ (%) | 36 | 35 | 0 | 0 |
| Carbonate | 151 | 0 | 0 | 6 |
| regeneration cost | | | | |
| ($/tonne of prod.) | | | | |
| Anode | 13 | 94 | 0 | 0 |
| separation cost | | | | |
| ($/tonne of prod.) | | | | |
| Total CO₂ cost | 164 | 94 | 0 | 6 |
| ($/tonne of prod.) | | | | |

SUPPLEMENTARY TABLE 6
Gas collection experiment to demonstrate the amount of dissolved
CO₂ in aqueous electrolytes. A 30 wt % MEA aqueous solution and a 2M
KCl solution, both saturated with CO₂, were heated for 15 min at 70° C.,
with and without prior N₂ purging. In both cases, ~4.3 mL of dissolved
CO₂ was removed due to N₂ purging, which corresponds closely
to the reported dissolved CO₂ solubility, ca. 34 mM. There was 1.5 mL
of gas collected in the KCl electrolyte even after N₂ purging and this is due
to dissolved N₂ and not CO₂, confirmed by gas chromatography. The error
bars represent the standard deviation of three independent measurements.

| | Without | With | Dissolved |
|---|---|---|---|
| | N₂ purging | N₂ purging | CO₂ |
| | (mL) | (mL) | (mL) |
| MEA electrolyte | 32.5 ± 0.5 | 28.5 ± 1 | 4 ± 0.5 |
| KCl electrolyte | 4.3 ± 0.5 | 1.5 ± 0 | 4.3 ± 0.5 |

SUPPLEMENTARY TABLE 7
Raman shift for MEA, MEA-CO₂ adducts and Nafion.

| | Raman Shift | |
|---|---|---|
| Species | (cm⁻¹) | Vibration mode |
| MEA/ | 730 | CH₂ rocking |
| MEACOO⁻/ | 870 | CH₃ rocking |
| MEAH⁺ | 1158 | C—N stretching |
| | 1293 | N—CH stretching |
| | 1375 | CC Stretching |
| | 1446 | CH bend |
| | 1552 | C═O stretching |
| | 1604 | NH₃_{⁺} deformation |
| | 2700-3000 | CH₂ symmetric/asymmetric |
| | | stretch |
| | | or NH₂_{⁺} stretching |
| Nafion | 682 | CF rocking |
| | 730 | CF stretching + |
| | | CCC stretching |
| | 805 | C—S stretching |
| | 894 | C—S stretching |
| | 970 | COC deformation |
| | 1064 | SO₃_{^{−}} symmetric stretching |
| | 1323 | SO₃_{^{−}} asymmetric stretching + |
| | | S═O symmetric stretching |
| | 1505 | C—C stretching |

SUPPLEMENTARY TABLE 8
Bulk electrolyte pH of the 2M MEA with 3M of KCl solution
during electrochemical regeneration. Electrolysis was conducted with
the same MEA/KCl electrolyte at 10 mA/cm² applied constant
current density, heated to 30° C. pH was measured after saturating
CO₂, during electrolysis, and at the end of electrolysis.

| | pH |
|---|---|
| MEA | 12.4 |
| MEA-CO₂ adducts | 8.3 |
| 1^{st} electrolysis | 9.4 |
| Re-purge with CO₂ | 8.7 |
| 2^{nd} electrolysis for 6 hr | 9.5 |
| Re-purge with CO₂ | 8.7 |
| 3^{rd} electrolysis for 5 hr | 9.1 |

In the above description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In the above description, an embodiment is an example or implementation of the inventions. The various appearances of “one embodiment,” “an embodiment”, “some embodiments” or “some implementations” do not necessarily all refer to the same embodiments or implementations. Although various features of the invention may be described in the context of a single embodiment or implementation, the features may also be provided separately or in any suitable combination. Conversely, although the invention may be described herein in the context of separate embodiments or implementations for clarity, the invention may also be implemented in a single embodiment or implementation.

It should be further noted that the contents of any patents, patent applications and publications that are recited herein and in provisional patent application U.S. 63/118,370 are incorporated herein by reference.

1. An electrolysis process for producing value-added products from an amine-CO₂ electrolyte solution, the process comprising:
providing the amine-CO₂ electrolyte solution comprising alkali cations and chemisorbed CO₂ under the form of an amine-CO₂ adduct; and
contacting the amine-CO₂ electrolyte solution with a working electrode under applied current density for electrolysing the amine-CO₂ adduct to form a product mixture comprising carbon monoxide (CO) and an amine;
wherein the alkali cations are selected to disrupt an electrochemical double layer (EDL) at a surface of the working electrode and enhance electron transfer to the amine-CO₂ adduct.

2. The process of claim 1, further comprising adding the alkali cations to an amine-solution to produce the amine-CO₂ electrolyte solution.

3. The process of claim 2, wherein the amine-CO₂ solution is a CO₂-enriched amine-based capture solution from an industrial CO₂ absorption process from flue gas.

4. An electrochemical process for conversion of CO₂ into value-added products comprising CO, the process comprising:
contacting CO₂ with an amine-based capture solution to chemically absorb CO₂ and produce an amine-CO₂ electrolyte solution comprising a carbamate; and
electrolysing the carbamate into the value-added products by contacting the amine-CO₂ electrolyte solution with a working electrode under applied current density in presence of alkali cations to form a product mixture comprising carbon monoxide (CO) and an amine;
wherein the alkali cations are selected to modify an electrochemical double layer (EDL) at a surface of the working electrode and thereby enhance electron transfer to the carbamate.

5. The process of claim 4, wherein the amine-based capture solution comprises the alkali cations.

6. The process of claim 5, further comprising adding the alkali cations to the amine-CO₂ electrolyte solution before electrolysing the carbamate into the value-added products.

7. The process of any one of claims 4 to 6, further comprising separating the amine from the product mixture and recycling thereof as at least part of the amine-based capture solution.

8. The process of any one of claims 1 to 7, wherein at least 80% of the chemisorbed CO₂ is converted into CO.

9. The process of any one of claims 1 to 8, wherein at least 90% of the chemisorbed CO₂ is converted into CO.

10. The process of any one of claims 1 to 9, wherein the alkali cations comprise at least one of K⁺, Rb⁺ and Cs⁺.

11. The process of any one of claims 1 to 10, wherein a molecular size of the alkali cations is smaller than the molecular size of the ammonium cation from the amine-CO₂ electrolyte solution.

12. The process of any one of claims 1 to 11, wherein the alkali cations have a Stark tuning slope that is higher than that of the ammonium cation from the amine-CO₂ electrolyte solution.

13. The process of any one of claims 1 to 12, wherein a Faradaic efficiency (FE) of CO₂-to-CO conversion is at least 30% at the applied current density between 5 mA/cm² and 300 mA/cm².

14. The process of claim 13, wherein the FE of CO₂-to-CO conversion is at least 30% at the applied current density between 5 mA/cm² and 100 mA/cm².

15. The process of claim 13 or 14, wherein the FE of CO₂-to-CO conversion is at least 50%.

16. The process of claim 13 or 14, wherein the FE of CO₂-to-CO conversion is at least 70%.

17. The process of any one of claims 1 to 16, wherein a distance between the carbamate and electrons forming an inner layer of the EDL is smaller than the distance resulting from electrolysis in absence of the alkali cations.

18. The process of any one of claims 1 to 17, wherein the amine is a primary amine.

19. The process of any one of claims 1 to 17, wherein the amine is a secondary amine.

20. The process of any one of claims 1 to 17, wherein the amine is a tertiary amine.

21. The process of any one of claims 1 to 17, wherein the amine is MEA, DEA or MDEA.

22. The process of any one of claims 1 to 17, wherein the amine is NR₁R₂R₃ and each of R₁, R₂ and R₃ is hydrogen, an alkyl group or an aryl group.

23. The process of any one of claims 1 to 22, wherein a concentration of the alkali cations in the amine-CO₂ electrolyte solution is between 0.1 M and 3 M.

24. The process of any one of claims 1 to 22, wherein a concentration of the alkali cations in the amine-CO₂ electrolyte solution is between 0.5 M and 2.5 M.

25. The process of any one of claims 1 to 22, wherein a concentration of the alkali cations in the amine-CO₂ electrolyte solution is between 1 M and 2 M.

26. The process of any one of claims 1 to 25, wherein a concentration in carbamate and ammonium ions in the amine-CO₂ electrolyte solution is between 1 M and 5 M.

27. The process of any one of claims 1 to 25, wherein a concentration in carbamate and ammonium ions in the amine-CO₂ electrolyte solution is between 1.5 M and 4.5 M.

28. The process of any one of claims 1 to 25, wherein a concentration in carbamate and ammonium ions in the amine-CO₂ electrolyte solution is between 2 M and 4 M.

29. The process of any one of claims 1 to 25, wherein a concentration in carbamate and ammonium ions in the amine-CO₂ electrolyte solution is between 2 M and 2.5 M.

30. The process of any one of claims 1 to 29, wherein the working electrode comprises an electrocatalyst.

31. The process of any one of claims 1 to 30, wherein the working electrode is fabricated by sputtering a metal on a substrate to form a metal film and spray-coating an ink containing metal nanoparticles onto the metal film.

32. The process of any one of claims 1 to 31, wherein the working electrode is an Ag cathode, an Ag-carbon black cathode or a Cu cathode.

33. The process of any one of claims 1 to 32, further comprising, before contacting the amine-CO₂ electrolyte solution with the working electrode under applied current density, purging the amine-CO₂ electrolyte solution with an inert gas to remove any dissolved CO₂.

34. The process of claim 33, wherein the inert gas is N₂.

35. The process of any one of claims 1 to 34, further comprising maintaining the amine-CO₂ electrolyte solution at a temperature between 19° C. and 80° C. during electrolysis.

36. The process of claim 35, wherein the temperature is maintained between 40° C. and 80° C.

37. The process of any one of claims 1 to 36, further comprising separating CO from the product mixture to produce a CO-enriched stream.

38. A method to enhance electrochemical conversion of CO₂ into value-added products in an amine-based electrochemical system, the method comprising adding alkali cations to an amine-based electrolyte solution to form a modified electrolyte solution so as to disrupt an electrochemical double layer (EDL) at a working electrode of the amine-based electrochemical system that generates CO from a carbamate present in the modified electrolyte solution.

39. The method of claim 38, further comprising at least one of the features defined in any one of claims 1 to 37.

40. An electrochemical system for conversion of chemisorbed CO₂ into CO, the system comprising:
a cathodic compartment for containing an amine-CO₂ catholyte solution comprising an amine-CO₂ adduct and alkali cations;
an anodic compartment for containing an anolyte solution;
a cathode being provided in the cathodic compartment;
an anode being provided in the anodic compartment;
a reference electrode being provided in the cathodic compartment;
a cation exchange cation membrane being provided between the anodic compartment and the cathodic compartment to control ion exchange therebetween;
an alkali addition unit having an outlet in fluid communication with a liquid inlet of the cathodic compartment to provide the alkali ions therein; and
a power source to provide electrical current at an applied current density and sustain electrolysis of the amine-CO₂ adduct from the amine-CO₂ catholyte solution;
wherein the alkali cations are selected to disrupt an electrochemical double layer (EDL) at a surface of the cathode during electrolysis of the amine-CO₂ adduct, and enhance electron transfer to the amine-CO₂ adduct for production of CO.

41. The system of claim 40, wherein the alkali addition unit is configured to add the alkali ions to an amine-CO₂ solution flowing into the cathodic compartment via the liquid inlet.

42. The system of claim 41, wherein the amine-CO₂ solution is a CO₂-enriched amine-based capture solution from an industrial CO₂ absorption process from flue gas.

43. The system of claim 40, wherein the alkali addition unit is configured to add the alkali ions to an amine solution flowing into the cathodic compartment via the liquid inlet.

44. The system of claim 43, wherein the cathodic compartment further has a gas inlet for receiving CO₂ and allowing chemisorption of CO₂ by the amine solution to form the amine-CO₂ catholyte solution comprising the amine-CO₂ adduct and the alkali cations, before providing electrical current via the power source.

45. The system of any one of claims 40 to 44, wherein the cathodic compartment further comprises at least one outlet to recover a product mixture comprising CO and the amine resulting from the electrolysis of the amine-CO₂ adduct.

46. The system of claim 45, wherein the cathodic compartment comprises a liquid outlet to recover a liquid component comprising the amine.

47. The system of claim 45 or 46, wherein the cathodic compartment comprises a gas outlet to recover a gas component comprising CO.

48. The system of any one of claims 40 to 47, wherein the alkali cations comprise at least one of K⁺, Rb⁺ and Cs⁺.

49. The system of any one of claims 40 to 48, wherein a molecular size of the alkali cations is lower than the molecular size of the ammonium cations of the amine-CO₂ catholyte solution.

50. The system of any one of claims 40 to 49, wherein the alkali cations have a Stark tuning slope that is higher than the one of the ammonium cations of the amine-CO₂ catholyte solution.

51. The system of any one of claims 40 to 50, wherein a Faradaic efficiency (FE) of CO₂-to-CO is at least 30% at an applied current density between 5 mA/cm² and 300 mA/cm².

52. The system of claim 51, wherein the FE of CO₂-to-CO is at least 30% at an applied current density between 5 mA/cm² and 100 mA/cm².

53. The system of claim 51 or 52, wherein the FE of CO₂-to-CO is at least 50%.

54. The system of claim 51 or 52, wherein the FE of CO₂-to-CO is at least 70%.

55. The system of any one of claims 40 to 54, wherein a distance between the amine-CO₂ adduct and electrons forming an inner layer of the EDL is lower than the distance resulting from electrolysis of the amine-CO₂ adduct in absence of the alkali cations.

56. The system of any one of claims 40 to 55, wherein the amine-CO₂ adduct is a carbamate deriving from a primary amine.

57. The system of any one of claims 40 to 55, wherein the amine-CO₂ adduct is a carbamate deriving from a secondary amine.

58. The system of any one of claims 40 to 55, wherein the amine-CO₂ adduct is a carbamate derived from a tertiary amine.

59. The system of any one of claims 40 to 55, wherein the amine-CO₂ adduct is a carbamate derived from MEA, DEA or MDEA.

60. The system of any one of claims 40 to 55, wherein the amine is NR₁R₂R₃ and each of R₁, R₂ and R₃ is hydrogen, an alkyl group or an aryl group.

61. The system of any one of claims 40 to 60, further comprising a control unit that is operatively connected to the alkali addition unit to provide the amine-CO₂ catholyte solution with a molar concentration ratio of the alkali cations over the amine-CO₂ adduct between 0.01 and 3.

62. The system of claim 61, wherein the molar concentration ratio of the alkali cations over the amine-CO₂ adduct is between 0.1 and 1.

63. The system of any one of claims 40 to 62, wherein a molar concentration of the alkali cations is between 0.1 M and 3 M.

64. The system of any one of claims 40 to 63, wherein a molar concentration of the amine-CO₂ adduct is between 1 M and 5 M.

65. The system of any one of claims 40 to 64, wherein the cathode comprises an electrocatalyst.

66. The system of any one of claims 40 to 65, wherein the cathode is fabricated by sputtering a metal on a substrate to form a metal film and spray-coating an ink containing metal nanoparticles onto the metal film.

67. The system of claim 66, wherein the substrate is carbon paper or PTFE.

68. The system of any one of claims 40 to 67, wherein the cathode is an Ag cathode, an Ag/carbon black cathode or a Cu cathode.

69. The system of any one of claims 40 to 68, wherein the anolyte solution is a KOH solution.

70. The system of any one of claims 40 to 69, wherein the reference electrode is an Ag/AgCl electrode.

71. The system of any one of claims 40 to 70, wherein the cation exchange membrane is a Nafion membrane.

72. The system of any one of claims 40 to 71, wherein the system is a three-electrode system.

73. The system of claim 72, wherein the anode comprises Pt, optionally provided in the form of a foil.

74. The system of any one of claims 40 to 71, wherein the system is a flow cell system.

75. The system of claim 74, wherein the anode comprises Ni, optionally provided in the form of a foam.

76. The system of claim 74 or 75, further comprising a peristaltic pump to circulate the anolyte solution and the amine-CO₂ catholyte solution within the flow cell system.

77. An electrolysis process for producing CO from an amine-CO₂ electrolyte solution, the process comprising:
obtaining an amine-CO₂ electrolyte solution derived from a CO₂ capture system, the amine-CO₂ electrolyte solution comprising chemisorbed CO₂ in the form of an amine-CO₂ adduct;
adding alkali cations to the amine-CO₂ electrolyte solution to form a modified electrolyte solution having a molar concentration ratio of alkali cations over amine-CO₂ adduct between 0.01 and 3;
subjecting the modifying solution to electrocatalysis to generate CO and an amine RNH₂ with R being an alkyl group, from the amine-CO₂ adduct at a working electrode under an applied current density between 5 and 300 mA/cm².

78. The process of claim 77, wherein the applied current density is between 5 and 100 mA/cm².

79. The process of claim 77 or 78, wherein the applied current density is between 10 and 100 mA/cm².

80. The process of any one of claims 77 to 79, wherein the molar concentration ratio of alkali cations over amine-CO₂ adduct between 0.1 and 1.

81. The process of any one of claims 77 to 80, further comprising at least one feature of the process defined in any one of claims 1 to 37.
